(19) United States
(12) Patent Application Publication
(10) Pub. No.: US 2017/0248861 A1
(43) Pub. Date: Aug. 31, 2017

(54) LIQUID DEVELOPER, LIQUID DEVELOPER CARTRIDGE, IMAGE FORMING APPARATUS AND IMAGE FORMING METHOD

(71) Applicant: FUJI XEROX CO., LTD., Tokyo (JP)

(72) Inventors: Chisato URANO, Ebina-shi (JP); Osamu IDE, Minamiashigara-shi (JP)

(73) Assignee: FUJI XEROX CO., LTD., Tokyo (JP)

(21) Appl. No.: 15/209,615

(22) Filed: Jul. 13, 2016

(30) Foreign Application Priority Data
Feb. 26, 2016 (JP) 2016-036279
Feb. 26, 2016 (JP) 2016-036280

(51) Int. Cl. G03G 9/00

(52) U.S. Cl. CPC G03G 9/132; G03G 9/125; G03G 9/0819; G03G 15/104

(57) ABSTRACT

A liquid developer contains: a toner particle; a carrier liquid; and either a polymer compound containing a monomer unit having a polysiloxane chain and a monomer unit having an amino group or a polymer compound containing a monomer unit having a polyester chain containing a cyclic structure and a monomer unit having an amino group.

### CROSS-REFERENCE TO RELATED APPLICATIONS

This application is based on and claims priority under 35 USC 119 from Japanese Patent Application No. 2016-036279 filed on Feb. 26, 2016 and Japanese Patent Application No. 2016-036280 filed on Feb. 26, 2016.

### BACKGROUND

### Technical Field

The present invention relates to a liquid developer, a liquid developer cartridge, an image forming apparatus and an image forming method.

### SUMMARY

According to an aspect of the invention, there is provided a liquid developer including a toner particle, a carrier liquid, and either a polymer compound containing a monomer unit having a polysiloxane chain and a monomer unit having an amino group or a polymer compound containing a monomer unit having a polyester chain containing a cyclic structure and a monomer unit having an amino group.

### BRIEF DESCRIPTION OF THE DRAWINGS

FIG. 1 is a schematic constitutional view showing an example of an image forming apparatus relating to an exemplary embodiment of the invention.

### DETAILED DESCRIPTION

The exemplary embodiment of the invention will be described below. The descriptions and examples are only for illustrating the exemplary embodiments and do not limit the scope of the invention.

The terms “alkane”, “alkyl”, “alkylene”, “alkene” and “alkenyl” as used in the specification include not only chain hydrocarbons but also cyclic hydrocarbons.

The term “(meth)acryl” as used in the specification is meant to include both “acryl” and “methacryl”, and the term “(meth)acrylate” as used in the specification is meant to include both “acrylate” and “methacrylate”.

The term “monomer unit” in a polymer compound as used in the specification includes both a constituting unit obtained by polymerization of a monomer and a constituting unit in which a constituting unit obtained by polymerization of a monomer is substituted with a substituent.

### <<Liquid Developer of First Aspect of Invention>>

A liquid developer according to an exemplary embodiment of a first aspect of the invention includes a toner particle, a carrier liquid, and a polymer compound containing a monomer unit having a polysiloxane chain and a monomer unit having an amino group. The polymer compound containing a monomer unit having a polysiloxane chain and a monomer unit having an amino group is also referred to as a “specific dispersant” hereinafter.

In the specific dispersant, the monomer unit having a polysiloxane chain and the monomer unit having an amino group are not necessarily separate monomer units. A polymer compound containing a monomer unit having a polysiloxane chain and an amino group also falls into the specific dispersant. As the specific dispersant, from the standpoint that the dispersibility of toner particle by the specific dispersant is more excellent and from the standpoint that synthesis of the specific dispersant is easy, the specific dispersant in which the monomer unit having a polysiloxane chain and the monomer unit having an amino group are contained as the separate monomer units is preferred.

The monomer unit having a polysiloxane chain of the specific dispersant includes a form in which the polysiloxane chain is present in a side chain of the monomer unit (that is, in a side chain of the specific dispersant) and a form in which the polysiloxane chain is present in a main chain of the monomer unit (that is, in a main chain of the specific dispersant), and from the standpoint that the dispersibility of toner particle by the specific dispersant is more excellent and from the standpoint that synthesis of the specific dispersant is easy, the form in which the polysiloxane chain is present in a side chain of the monomer unit is preferred. In the form in which the polysiloxane chain is present in a side chain of the monomer unit, the position of the polysiloxane chain in the side chain is not particularly limited. In the monomer unit having a polysiloxane chain, it is preferred that the polysiloxane chain constitutes a terminal of the side chain.

The specific dispersant has the polysiloxane chain which is a compatible group with the carrier liquid and the amino group which is a compatible group with the toner particle. The specific dispersant exhibits solubility in the carrier liquid by having the polysiloxane chain and is compatible with the toner particle (in particular, toner particle containing a binder resin having an acidic group, for example, a carboxyl group) by having the amino group so that it is presumed to exhibits the dispersion power of toner particle in the liquid developer including the carrier liquid.

The liquid developer according to the exemplary embodiment which includes a combination of a hydrocarbon preferable as the main component of the carrier liquid and the polysiloxane chain which is a chemical substance of a different kind from the hydrocarbon as the compatible group of the dispersant is considered to be excellent in the dispersibility of toner particle in comparison with, for example, a combination of silicon oil as the main component of the carrier liquid and the polysiloxane chain which is a chemical substance of the same kind as the silicon oil as the compatible group of the dispersant. The reason therefor is presumed to be as follows.

It is unavoidable to permeate water molecules in environment (for example, in the air) into the liquid developer, but it is considered that when the carrier liquid and the compatible group of the dispersant forms a combination of chemical substances of different kinds as in the exemplary embodiment, an electric charge deviation occurs between the two and the electric charge deviation acts on polarity of the water molecules to disperse the water molecules so that dispersion destabilization of the toner particle resulting from clustering of the water molecules is suppressed and as a result, the dispersibility of toner particle (in particular, the dispersibility of toner particle with the passage of time) is excellent.

Since the liquid developer according to the exemplary embodiment is excellent in the dispersibility of toner particle, the presence of coarse particle resulting from aggregation of the toner particle with each other is suppressed. Since the liquid developer according to the exemplary embodiment is excellent in the dispersibility of toner particle, reduction in fine line reproducibility is suppressed.

### <<Liquid Developer of Second Aspect of Invention>>

A liquid developer according to an exemplary embodiment of a second aspect of the invention includes a toner particle, a carrier liquid, and a polymer compound containing a monomer unit having a polyester chain containing a cyclic structure and a monomer unit having an amino group. The polymer compound containing a monomer unit having a polyester chain containing a cyclic structure and a monomer unit having an amino group is also referred to as a “specific dispersant”, and the polyester chain containing a cyclic structure is also referred to as a “cyclic polyester chain” hereinafter.

In the specific dispersant, the monomer unit having a polyester chain containing a cyclic structure and the monomer unit having an amino group are not necessarily separate monomer units. A polymer compound containing a monomer unit having a polyester chain containing a cyclic structure and an amino group also falls into the specific dispersant. As the specific dispersant, from the standpoint that the dispersibility of toner particle by the specific dispersant is more excellent and from the standpoint that synthesis of the specific dispersant is easy, the specific dispersant in which the monomer unit having a polyester chain containing a cyclic structure and the monomer unit having an amino group are contained as the separate monomer units is preferred.

The monomer unit having a polyester chain containing a cyclic structure of the specific dispersant includes a form in which the cyclic polyester chain is present in a side chain of the monomer unit (that is, in a side chain of the specific dispersant) and a form in which the cyclic polyester chain is present in a main chain of the monomer unit (that is, in a main chain of the specific dispersant), and from the standpoint that the dispersibility of toner particle by the specific dispersant is more excellent and from the standpoint that synthesis of the specific dispersant is easy, the form in which the cyclic polyester chain is present in a side chain of the monomer unit is preferred. In the form in which the cyclic polyester chain is present in a side chain of the monomer unit, the position of the cyclic polyester chain in the side chain is not particularly limited. In the monomer unit having a polyester chain containing a cyclic structure, it is preferred that the cyclic polyester chain constitutes a terminal of the side chain.

The specific dispersant has the cyclic polyester chain which is a compatible group with the carrier liquid and the amino group which is a compatible group with the toner particle. The specific dispersant exhibits solubility in the carrier liquid by having the cyclic polyester chain and is compatible with the toner particle (in particular, toner particle containing a binder resin having an acidic group, for example, a carboxyl group) by having the amino group so that it is presumed to exhibits the dispersion power of toner particle in the liquid developer including the carrier liquid.

Moreover, since in the specific dispersant, the intramolecular and intermolecular entanglement is suppressed by steric hindrance due to the cyclic structure contained in the cyclic polyester chain, the specific dispersant is excellent in the dispersion power of toner particle and thus, it is presumed that the liquid developer according to the exemplary embodiment is excellent in the dispersibility of toner particle.

Since the liquid developer according to the exemplary embodiment is excellent in the dispersibility of toner particle, the presence of coarse particle resulting from aggregation of the toner particle with each other is suppressed. Since the liquid developer according to the exemplary embodiment is excellent in the dispersibility of toner particle, reduction in fine line reproducibility is suppressed.

Moreover, the liquid developer according to the exemplary embodiment is excellent in image fixability. The reason therefor is presumed to be that since the specific dispersant has the cyclic polyester chain, good compatibility between the specific dispersant and the binder resin (particularly, polyester resin) contained in the toner particle is maintained in the fixed image.

The components of the liquid developer according to the invention will be described in detail below.

### <Carrier Liquid>

The carrier liquid of the invention is an insulating liquid for dispersing the toner particle. The carrier liquid may be either non-volatile or volatile, and a non-volatile carrier liquid is preferred. In the liquid developer according to the exemplary embodiment of the invention, the insulation means that the electric conductivity is 10⁻¹⁰ S/m or less, and the non-volatility means that the flash temperature is 130° C. or more or the volatile amount after allowing to stand at 150° C. for 24 hours is 8% by weight or less. The flash temperature is a temperature measured in accordance with JIS K2265-4: 2007.

Examples of the carrier liquid include a hydrocarbon (aliphatic hydrocarbon and aromatic hydrocarbon); a silicone oil, for example, dimethyl silicone oil, methyl hydrogen silicone oil or methyl phenyl silicone oil; and a polyol compound, for example, ethylene glycol, diethylene glycol or propylene glycol. The carrier liquids may be used individually or in combination of two or more thereof.

The carrier liquid in the liquid developer of the invention preferably contains a hydrocarbon as the main component. The main component of the carrier liquid means a chemical substance occupying 50% by weight or more of the total carrier liquid.

The carrier liquid containing a hydrocarbon as the main component is a carrier liquid in which a ratio of the hydrocarbon occupied in the total carrier liquid is 50% by weight or more. The ratio of the hydrocarbon occupied in the total carrier liquid is preferably 80% by weight or more, more preferably 90% by weight or more, still more preferably 95% by weight or more, and it is particularly preferred that the carrier liquid substantially contains only the hydrocarbon.

Examples of the hydrocarbon which is the preferred main component of the carrier liquid include an aliphatic hydrocarbon, for example, isoparaffin, normal paraffin, naphthene or olefin and an aromatic hydrocarbon. The hydrocarbons may be used individually or in combination of two or more thereof. The hydrocarbon which is the preferred main component of the carrier liquid is preferably an aliphatic hydrocarbon, and more preferably a paraffin.

Examples of commercially available product of the hydrocarbon include Isopar L (isoparaffin), Isopar M (isoparaffin), Exxsol D80 (naphthene), Exxsol D110 (naphthene), Solvesso 100 (aromatic hydrocarbon) and Solvesso 150 (aromatic hydrocarbon) produced by Exxon Mobil Corp.; Moresco White P-40 (paraffin), Moresco White P-100 (paraffin) and Moresco White P-200 (paraffin) produced by Moresco Corp.; and Naphtesol 200 (naphthene) and Naphtesol 220 (naphthene) produced by JX Nippon Oil & Energy Corp.

The carrier liquid may contain, for example, a dispersant other than the specific dispersant, an emulsifier, a surfactant, a stabilizer, a wetting agent, a thickener, a foaming agent, an antifoamer, a coagulant, a gelling agent, an antisettling agent, a charge controlling agent, a charge prevention agent, an antioxidant, a softener, a filler, a reodorant, an antitack agent and a release agent.

### <Specific Dispersant Included in Liquid Developer of First Aspect of Invention>

The specific dispersant is a polymer compound containing at least a monomer unit having a polysiloxane chain and a monomer unit having an amino group, and may contain other monomer unit. The other monomer unit contained in the specific dispersant includes, for example, a monomer unit having a long-chain hydrocarbon group. In the case where the specific dispersant contains the monomer unit having a long-chain hydrocarbon group, the form in which the monomer unit having a polysiloxane chain, the monomer unit having an amino group and the monomer unit having a long-chain hydrocarbon group are contained as separate monomer units is preferred.

The specific dispersant is, for example, a copolymer obtained by polymerization of a monomer having an ethylenically unsaturated double bond. In this case, the main chain of the specific dispersant is a polymer structure obtained by polymerization of the monomer having an ethylenically unsaturated double bond, and specific examples thereof include a poly(meth)acryl structure, a polyvinyl structure, a polyolefin structure, a polybutadiene structure, a polyisoprene structure and a structure composed of a mixture of these structures.

The weight average molecular weight (Mw) of the specific dispersant is preferably from 5,000 to 50,000, more preferably from 10,000 to 40,000, still more preferably from 15,000 to 35,000, and yet more preferably from 20,000 to 30,000.

The weight average molecular weight (Mw) of the specific dispersant is measured by gel permeation chromatography (GPC). The measurement is performed by using HCL-8120 GPC, SC-8020 (produced by Tosoh Corp.) as a measurement apparatus, two columns of TSKgel Supper HM-M (6.0 mm ID×15 cm) (produced by Tosoh Corp.) as columns, and tetrahydrofuran as an eluent. The measurement conditions are a sample concentration of 0.5% by weight, a flow rate of 0.6 mL/min, a sample injection volume of 10 μL and a measuring temperature of 40° C., and detection is conducted by an RI detector. The calibration curve is prepared from 10 samples of “polystyrene standard sample TSK standard: A-500, F-1, F-10, F-80, F-380, A-2500, F-4, F-40, F-128 and F-700 produced by Tosoh Corp.

### [Monomer Unit Having Polysiloxane Chain]

The monomer unit having a polysiloxane chain includes a monomer unit obtained by polymerization of a monomer having a polysiloxane chain and a monomer unit in which a monomer unit obtained by polymerization of a monomer having no polysiloxane chain is substituted with a group having a polysiloxane chain.

The polysiloxane chain in the monomer unit having a polysiloxane chain is preferably a polyalkyl(C1 to C6) siloxane chain, and more preferably a polydimethylsiloxane chain, from the standpoint that the dispersibility of toner particle by the specific dispersant is more excellent.

The average polymerization degree of the polysiloxane chain in the monomer unit having a polysiloxane chain is preferably 5 or more, more preferably 10 or more, from the standpoint that the dispersibility of toner particle by the specific dispersant is more excellent, and is preferably 60 or less, more preferably 50 or less, still more preferably 30 or less, from the standpoint the solubility of the specific dispersant in the carrier liquid.

The monomer having a polysiloxane chain (also referred to as a “polysiloxane macromonomer”) can be prepared, for example, by introducing an ethylenically unsaturated double bond into one terminal of the polysiloxane chain. The polysiloxane macromonomer includes, for example, a monomer in which one terminal of the polysiloxane is modified with (meth)acrylic acid. The polysiloxane macromonomers may be used individually or in combination of two or more thereof.

The monomer unit having a polysiloxane chain is preferably a monomer unit obtained by polymerization of a monomer represented by formula (1) shown below.

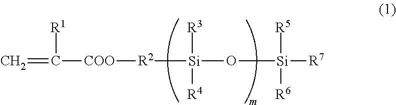

In formula (1), R¹ represents a hydrogen atom or a methyl group. R² represents a divalent aliphatic hydrocarbon group having from 1 to 10 carbon atoms, and is preferably an alkylene group having from 1 to 6 carbon atoms. Each of R³ to R⁷ independently represents an alkyl group having from 1 to 6 carbon atoms. Each of R¹ to R⁷ independently may be substituted with a halogen atom (for example a fluorine atom). m represents an average polymerization degree, and is preferably from 5 to 60, more preferably from 10 to 50, still more preferably from 10 to 30, and yet more preferably from 10 to 20.

The monomer unit having a polysiloxane chain is more preferably a monomer unit obtained by polymerization of a monomer represented by formula (2) shown below.

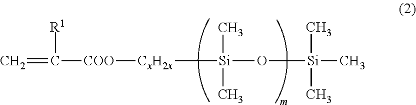

In formula (2), R¹ represents a hydrogen atom or a methyl group. x represents an integer from 1 to 6, preferably an integer from 1 to 4, and more preferably 2 or 3. m represents an average polymerization degree, and is preferably from 5 to 60, more preferably from 10 to 50, still more preferably from 10 to 30, and yet more preferably from 10 to 20.

Examples of commercially available product of the polysiloxane macromonomer include, for example, Silaplane FM-0711 (in formula (2) wherein x is 3 and m is 12, weight average molecular weight: 1,000), Silaplane FM-0721 (in formula (2) wherein x is 3 and m is 67, weight average molecular weight: 5,000), Silaplane FM-0725 (in formula (2) wherein x is 3 and m is 135, weight average molecular weight: 10,000) produced by Chisso Corp. The polysiloxane macromonomers may be used individually or in combination of two or more thereof.

The content ratio of the monomer unit having a polysiloxane chain to the total polymer units constituting the specific dispersant is preferably 5% by mole or more, more preferably 8% by mole or more, still more preferably 10% by mole or more, from the standpoint that the dispersibility of toner particle by the specific dispersant is more excellent, and is preferably 25% by mole or less, more preferably 20% by mole or less, from the standpoint of image fixability.

### [Monomer Unit Having Amino Group]

The monomer unit having an amino group includes a monomer unit obtained by polymerization of a monomer having an amino group and a monomer unit in which a monomer unit obtained by polymerization of a monomer having no amino group is substituted with an amino group.

The amino group in the monomer unit having an amino group may be any of a primary amino group (—NH₂), a secondary amino group (—NHR) and a tertiary amino group (—NRR′), and the tertiary amino group is preferred from the standpoint that the dispersibility of toner particle by the specific dispersant is more excellent. The tertiary amino group is preferably a dialkylamino group (—NRR′, wherein each of R and R′ represents an alkyl group, and is preferably an alkyl group having from 1 to 4 carbon atoms), more preferably a dimethylamino group or a diethylamino group, and still more preferably a dimethylamino group.

The monomer having an amino group includes, for example, the monomers shown below. The monomers may be used individually or in combination of two or more thereof.

The monomer having a tertiary amino group includes, for example, a dialkylamino group-containing (meth)acrylate, for example, N,N-dimethylaminoethyl acrylate (DMAEA, alias, 2-(dimethylamino)ethyl acrylate), N,N-dimethylaminoethyl methacrylate (DMAEM, alias, 2-(dimethylamino)ethyl methacrylate), N,N-diethylaminoethyl acrylate (DEAEA, alias, 2-(diethylamino)ethyl acrylate), N,N-diethylaminoethyl methacrylate (DEAEM, alias, 2-(diethylamino)ethyl methacrylate), N,N-dimethylaminopropyl acrylate (DMAPA, alias, 2-(dimethylamino)propyl acrylate), N,N-dimethylaminopropyl methacrylate (DMAPM, alias, 2-(dimethylamino)propyl methacrylate), N,N-diethylaminopropyl acrylate (DEAPA, alias, 2-(diethylamino)propyl acrylate) or N,N-diethylaminopropyl methacrylate (DEAPM, alias, 2-(diethylamino)propyl methacrylate); a dialkylamino group-containing (meth)acrylamide, for example, N-(2-dimethylaminoethyl)(meth)acrylamide, N-(2-diethylaminoethyl)(meth)acrylamide, N-(2-dimethylaminopropyl)(meth)acrylamide or N-(2-diethylaminopropyl)(meth)acrylamide; and an amino group-containing styrene, for example, 3-(dimethylamino)styrene, α-methyl-3-(dimethylamino)styrene, 3-(diethylamino)styrene, 4-(dimethylamino)styrene, α-methyl-4-(dimethylamino)styrene or 4-(diethylamino)styrene.

The monomer having a secondary amino group includes, for example, 2-(methylamino)ethyl (meth)acrylate, 2-(tert-butylamino)ethyl (meth)acrylate and 2,2,6,6-tetramethyl-4-piperidyl (meth)acrylate.

The monomer having a primary amino group includes, for example, 2-aminoethyl (meth)acrylate.

The monomer unit having an amino group also includes a monomer unit in which a monomer unit obtained by polymerization of a monomer having no amino group is substituted with an amino group. For example, glycidyl (meth)acrylate is copolymerized with a monomer having a polysiloxane chain and then, a glycidyl group derived from the glycidyl (meth)acrylate is reacted with a compound having amino groups at both terminals, for example, ethylenediamine to introduce an amino group, thereby obtaining the monomer unit having an amino group.

The monomer unit having an amino group is preferably a monomer unit obtained by polymerization of a monomer represented by formula (3) shown below, that is, a monomer unit obtained by polymerization of a dialkylamino group-containing (meth)acrylate, for example, DMAEA, DMAEM, DEAEA, DEAEM, DMAPA, DMAPM, DEAPA or DEAPM.

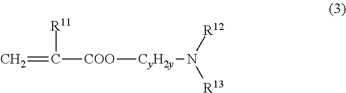

In formula (3), R¹¹ represents a hydrogen atom or a methyl group. Each of R¹² and R¹³ independently represents an alkyl group having from 1 to 4 carbon atoms, and is preferably a methyl group or an ethyl group. Each of R¹¹ to R¹³ independently may be substituted with a halogen atom (for example a fluorine atom). y represents an integer from 1 to 6, preferably an integer from 1 to 4, and more preferably 2 or 3.

The content ratio of the monomer unit having an amino group to the total polymer units constituting the specific dispersant is preferably 5% by mole or more, more preferably 8% by mole or more, from the standpoint that the dispersibility of toner particle by the specific dispersant is more excellent, and is preferably 25% by mole or less, more preferably 20% by mole or less, still more preferably 15% by mole or less, from the standpoint of image fixability.

### [Monomer Unit Having Long-Chain Hydrocarbon Group]

The long-chain hydrocarbon group in the monomer unit having a long-chain hydrocarbon group includes, for example, a hydrocarbon group having 10 or more carbon atoms in the main chain, and is preferably a hydrocarbon group having from 10 to 20 carbon atoms in the main chain, and more preferably a hydrocarbon group having from 12 to 18 carbon atoms in the main chain. The position of the long-chain hydrocarbon group in the monomer unit having a long-chain hydrocarbon group is not particularly limited, and it is preferred that the long-chain hydrocarbon group is present at the terminal of the side chain.

The long-chain hydrocarbon group in the monomer unit having a long-chain hydrocarbon group may be a saturated hydrocarbon group or an unsaturated hydrocarbon group, may be a hydrocarbon group containing no cyclic structure or a hydrocarbon group containing a cyclic structure, or may be a straight-chain hydrocarbon group or a branched hydrocarbon group.

The long-chain hydrocarbon group in the monomer unit having a long-chain hydrocarbon group is preferably an aliphatic hydrocarbon group, more preferably an aliphatic saturated hydrocarbon group, and still more preferably an aliphatic saturated hydrocarbon group containing no cyclic structure, from the standpoint of flexibility of the chain. The long-chain hydrocarbon group is preferably a straight-chain aliphatic saturated hydrocarbon group containing no cyclic structure and having from 10 to 20 carbon atoms, and more preferably a straight-chain aliphatic saturated hydrocarbon group containing no cyclic structure and having from 12 to 18 carbon atoms.

The monomer having a long-chain hydrocarbon group includes, for example, an alkyl ester of (meth)acrylic acid, specifically, decyl (meth)acrylate, dodecyl(meth)acrylate, 2-butyloctyl (meth)acrylate, tetradecyl (meth)acrylate, hexadecyl (meth)acrylate, octadecyl (meth)acrylate and eicosyl (meth)acrylate. The monomers may be used individually or in combination of two or more thereof.

The content ratio of the monomer unit having a long-chain hydrocarbon group to the total polymer units constituting the specific dispersant is preferably 5% by mole or more, more preferably 8% by mole or more, still more preferably 10% by mole, from the standpoint that the dispersibility of toner particle by the specific dispersant is more excellent, and is preferably 25% by mole or less, more preferably 20% by mole or less, from the standpoint of image fixability.

### [Other Monomer Unit]

The specific dispersant may contain other monomer unit other than the monomer units described above. The other monomer unit includes, for example, a monomer unit obtained by polymerization of a monomer having an ethylenically unsaturated double bond.

The monomer constituting the other monomer unit is preferably a lower alkyl (for example, having from 1 to 9 carbon atoms) ester of (meth)acrylic acid, and specifically includes, for example, methyl (meth)acrylate, ethyl (meth)acrylate, propyl (meth)acrylate, butyl (meth)acrylate, hexyl (meth)acrylate and 2-ethylhexyl (meth)acrylate. The monomers may be used individually or in combination of two or more thereof.

The blending amount of the specific dispersant is preferably from 0.1 part by weight to 10 parts by weight, more preferably from 0.5 parts by weight to 5 parts by weight, still more preferably from 1 part by weight to 3 parts by weight, based on 100 parts by weight of the toner particle.

### [Production Method of Specific Dispersant]

The specific dispersant is produced, for example, by solution polymerization using monomers constituting the respective monomer units and a polymerization initiator. The solvent used for the solution polymerization is preferably a same kind of solvent as the carrier liquid, a solvent which can be substituted with the carrier liquid (for example, a solvent having a boiling point lower than that of the carrier liquid) or a mixed solvent thereof. The polymerization initiator used in the solution polymerization includes, for example, an azo compound and an organic peroxide.

The specific dispersant may be added to the carrier liquid in the state of being dissolved in the solvent used in the solution polymerization or may be added to the carrier liquid in the state of solid obtained after removing the solvent used in the solution polymerization.

### <Specific Dispersant Included in Liquid Developer of Second Aspect of Invention>

The specific dispersant is a polymer compound containing at least a monomer unit having a cyclic polyester chain and a monomer unit having an amino group, and may contain other monomer unit. The other monomer unit contained in the specific dispersant includes, for example, a monomer unit having a long-chain hydrocarbon group. In the case where the specific dispersant contains the monomer unit having a long-chain hydrocarbon group, the form in which the monomer unit having a cyclic polyester chain, the monomer unit having an amino group and the monomer unit having a long-chain hydrocarbon group are contained as separate monomer units is preferred.

The specific dispersant is, for example, a copolymer obtained by polymerization of a monomer having an ethylenically unsaturated double bond. In this case, the main chain of the specific dispersant is a polymer structure obtained by polymerization of the monomer having an ethylenically unsaturated double bond, and specific examples thereof include a poly(meth)acryl structure, a polyvinyl structure, a polyolefin structure, a polybutadiene structure, a polyisoprene structure and a structure composed of a mixture of these structures.

The weight average molecular weight (Mw) of the specific dispersant is preferably from 5,000 to 100,000, more preferably from 10,000 to 50,000, and still more preferably from 15,000 to 35,000.

The weight average molecular weight (Mw) of the specific dispersant is measured by gel permeation chromatography (GPC). The measurement is performed by using HCL-8120 GPC, SC-8020 (produced by Tosoh Corp.) as a measurement apparatus, two columns of TSKgel Supper HM-M (6.0 mm ID×15 cm) (produced by Tosoh Corp.) as columns, and tetrahydrofuran as an eluent. The measurement conditions are a sample concentration of 0.5% by weight, a flow rate of 0.6 mL/min, a sample injection volume of 10 μL and a measuring temperature of 40° C., and detection is conducted by an RI detector. The calibration curve is prepared from 10 samples of “polystyrene standard sample TSK standard: A-500, F-1, F-10, F-80, F-380, A-2500, F-4, F-40, F-128 and F-700 produced by Tosoh Corp.

### [Monomer Unit Having Cyclic Polyester Chain]

The monomer unit having a cyclic polyester chain includes a monomer unit obtained by polymerization of a monomer having a cyclic polyester chain and a monomer unit in which a monomer unit obtained by polymerization of a monomer having no cyclic polyester chain is substituted with a group having a cyclic polyester chain.

The cyclic polyester chain in the monomer unit having a cyclic polyester chain includes, for example, a cyclic polyester chain having a cyclic structure derived from a dicarboxylic acid, a cyclic polyester chain having a cyclic structure derived from a diol, and a cyclic polyester chain having a cyclic structure derived from a dicarboxylic acid and a cyclic structure derived from a diol.

The cyclic structure contained in the cyclic polyester chain may be an alicyclic ring (aliphatic ring) or an aromatic ring. The alicyclic ring may be any of a monocyclic ring, a bridged ring (for example, dicyclic ring or tricyclic ring) and spiro ring, or may be a saturated hydrocarbon or an unsaturated hydrocarbon. The aromatic ring may be any of a monocyclic ring and a condensed ring (for example, dicyclic ring or tricyclic ring). The cyclic polyester chain preferably contains the alicyclic ring from the standpoint that the dispersibility of toner particle by the specific dispersant is more excellent.

The cyclic polyester chain is preferably a cyclic polyester chain containing at least one of a cyclohexane ring, a cyclohexene ring, a bicyclo[4.4.0]decane ring and a bicyclo[4.4.0]decadiene ring.

In the specification, the polyester chain in which the ring structures are mainly composed of alicyclic rings is referred to as an “alicyclic polyester chain”, and the polyester chain in which the ring structures are mainly composed of aromatic rings is referred to as an “aromatic cyclic polyester chain”.

The weight average molecular weight of the cyclic polyester chain is preferably 1,000 or more from the standpoint that the dispersibility of toner particle by the specific dispersant is more excellent, and is preferably 3,000 or less, more preferably 2,000 or less from the standpoint of solubility of the specific dispersant in the carrier liquid.

The monomer having the cyclic polyester chain can be prepared, for example, by introducing an ethylenically unsaturated double bond into one terminal or both terminals of the cyclic polyester chain. The monomer having the cyclic polyester includes, for example, a monomer in which one terminal or both terminals of the cyclic polyester is modified with (meth)acrylic acid. The monomers having the cyclic polyester chain may be used individually or in combination of two or more thereof.

The alicyclic polyester chain can be prepared by performing condensation polymerization between a dicarboxylic acid and a diol while incorporating at least one of an alicyclic dicarboxylic acid (for example, cyclohexanedicarboxylic acid), an acid anhydride of alicyclic dicarboxylic acid, a lower alkyl (for example, from 1 to 5 carbon atoms) ester of alicyclic dicarboxylic acid and an alicyclic diol (for example, cyclohexanediol, cyclohexane dimethanol or hydrogenated bisphenol A) into the polymerization component.

The aromatic cyclic polyester chain can be prepared by performing condensation polymerization between a dicarboxylic acid and a diol while incorporating at least one of an aromatic dicarboxylic acid (for example, terephthalic acid, isophthalic acid, phthalic acid or naphthalenedicarboxylic acid), an acid anhydride of aromatic cyclic dicarboxylic acid, a lower alkyl (for example, from 1 to 5 carbon atoms) ester of aromatic cyclic dicarboxylic acid and an aromatic diol (for example, ethylene oxide adduct of bisphenol A or propylene oxide adduct of bisphenol A) into the polymerization component.

The cyclic polyester chain containing at least any one of a cyclohexane ring, a cyclohexene ring, a bicyclo[4.4.0]decane ring and a bicyclo[4.4.0]decadiene ring can be prepared, for example, by the method described below.

An unsaturated fatty acid having from 2 to 4 (preferably 2) ethylenic double bonds or an ester thereof (first unsaturated fatty acid or ester thereof) and an unsaturated fatty acid having from 1 to 4 (preferably one or 2) ethylenic double bonds or an ester thereof (second unsaturated fatty acid or ester thereof) are subjected, for example, to transfer of the double bond and/or Diels-Alder reaction to be dimerized, thereby preparing a dimer acid having a cyclohexene ring or a bicyclo[4.4.0]decadiene ring. The resulting dimer acid is hydrogenated to prepare a dimer acid having a cyclohexane ring or a bicyclo[4.4.0]decane ring.

A reaction product (ester) of the dimer acid having any one of the cyclic structures described above with an alcohol (for example, methanol) is reduced to prepare a dimer diol having any one of the cyclic structures described above.

Then, at least one of the dimer acid and dimer diol described above is incorporated into the polymerization component, and condensation polymerization between a dicarboxylic acid and a diol is performed to prepare a cyclic polyester chain containing at least one of a cyclohexane ring, a cyclohexene ring, a bicyclo[4.4.0]decane ring and a bicyclo[4.4.0]decadiene ring.

The unsaturated fatty acid having from 2 to 4 ethylenic double bonds or the ester thereof, which is used in the preparation of the dimer acid, is preferably an unsaturated fatty acid having from 12 to 24 carbon atoms or an ester thereof, and includes, for example, tetradecadienoic acid, hexadecadienoic acid, octadecadienoic acid (for example, linoleic acid), eidosadienoic acid, docosadienoic acid, octadecatrienoic acid (linolenic acid) and eicosatetraenoic acid (for example, arachidonic acid). The unsaturated fatty acid having one ethylenic double bond or the ester thereof, which is used in the preparation of the dimer acid, is preferably an unsaturated fatty acid having from 12 to 24 carbon atoms or an ester thereof, and includes, for example, tetradecenoic acid, hexadecenoic acid, octadecenoic acid (for example, oleic acid, elaidic acid or vaccenic acid), eicocenoic acid (for example, gadoleic acid) and dococenoic acid (for example, erucic acid).

The dimer acid obtained by the preparation method described above is ordinarily a mixture of plural kinds of dimer acids different in the chemical structure depending on the position of the double bond in the unsaturated fatty acid, which is used in the preparation of the dimer acid, and the degree of hydrogenation of the dimer acid, and also a mixture of dimer acid having a ring structure and a dimer acid having no ring structure. Moreover, there is a case in which a monomer acid and/or a trimer acid is mixed in the dimer acid obtained by the preparation method described above.

Examples of the chemical structure of the dimer acid having a cyclohexane ring, a cyclohexene ring, a bicyclo[4.4.0]decane ring or a bicyclo[4.4.0]decadiene ring are shown below. In the structural formulae shown below, each of a, b, c and d represents an integer, and total number of carbon atoms included in the molecule is, for example, from 24 to 48.

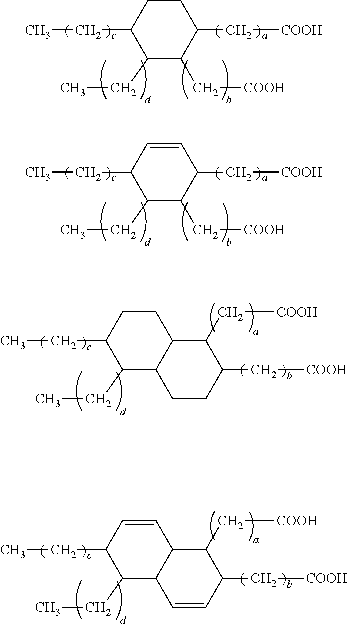

According to an example of the exemplary embodiment, the cyclic polyester chain in the monomer unit having a cyclic polyester chain includes a cyclic polyester containing a structural unit obtained by polymerization of at least one selected from a dimer acid having a ring structure, which is a dimer acid obtained by dimerizing an unsaturated fatty acid having from 12 to 24 carbon atoms or an ester thereof, a hydrogenated dimer acid obtained by hydrogenating the dimer acid described above and a dimer diol derived from the dimer acid or the hydrogenated dimer acid described above. The ring structure described above is preferably at least any one of a cyclohexane ring, a cyclohexene ring, a bicyclo[4.4.0]decane ring or a bicyclo[4.4.0]decadiene ring.

Examples of commercially available product of the cyclic polyester derived from a dimer acid include, for example, Priplast 1901 (polyester diol having hydroxyl groups at both terminals, weight average molecular weight: 2,000), Priplast 3197 (polyester diol having hydroxyl groups at both terminals, weight average molecular weight: 2,000) and Priplast 3186 (polyester diol having hydroxyl groups at both terminals, weight average molecular weight: 1,700) produced by Croda Japan KK.

By modifying one terminal or both terminals of the Priplast described above with (meth)acrylic acid, the monomer having a cyclic polyester chain can be prepared.

The content ratio of the monomer unit having a cyclic polyester chain to the total polymer units constituting the specific dispersant is preferably 1% by mole or more, more preferably 5% by mole or more, from the standpoint that the dispersibility of toner particle by the specific dispersant is more excellent, and is preferably 25% by mole or less, more preferably 20% by mole or less, still more preferably 10% by mole or less, from the standpoint of image fixability.

### [Monomer Unit Having Amino Group]

Since the description of the monomer unit having an amino group contained in the specific dispersant included in the liquid developer of the second aspect of the invention is same as the description of the monomer unit having an amino group contained in the specific dispersant included in the liquid developer of the first aspect described above, the description is omitted.

### [Monomer Unit Having Long-Chain Hydrocarbon Group]

Since the description of the monomer unit having a long-chain hydrocarbon group arbitrarily contained in the specific dispersant included in the liquid developer of the second aspect of the invention is same as the description of the monomer unit having a long-chain hydrocarbon group arbitrarily contained in the specific dispersant included in the liquid developer of the first aspect described above, the description is omitted.

### [Other Monomer Unit]

The specific dispersant included in the liquid developer of the second aspect of the invention may contain other monomer unit other than the monomer units described above. Since the description of the other monomer unit is same as the description of the other monomer unit which may be contained in the specific dispersant included in the liquid developer of the first aspect described above, the description is omitted.

### [Production Method of Specific Dispersant]

Since the description of the production method of the specific dispersant included in the liquid developer of the second aspect of the invention is same as the description of the production method of the specific dispersant included in the liquid developer of the first aspect described above, the description is omitted.

### <Toner Particle>

The toner particle of the invention contains, for example, a binder resin, a coloring agent and a release agent. The toner particle may be transparent toner containing no coloring agent. An external additive may adheres to the surface of the toner particle.

The toner particle may be a toner particle having a single layer structure or may be a toner particle having a so-called core-shell structure composed of a core part (core particle) and a covering layer (shell layer) covering the core part.

The volume average particle diameter of the toner particle is preferably from 0.1 μm to 6 μm, more preferably from 0.1 μm to 4 μm, and still more preferably from 0.5 μm to 3 μm.

The materials of the toner particle are described below.

### [Binder Resin]

The binder resin of the toner particle includes, for example, a vinyl resin composed of a homopolymer of a monomer, for example, a styrene (for example, styrene, p-chlorostyrene or α-methylstyrene), a (meth)acrylic acid ester (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate or 2-ethylhexyl methacrylate), an ethylenically unsaturated nitrile (for example, acrylonitrile or methacrylonitrile), a vinyl ether (for example, vinyl methyl ether or vinyl isobutyl ether), a vinyl ketone (for example, vinyl methyl ketone, vinyl ethyl ketone or vinyl isopropenyl ketone) or an olefin (for example, ethylene, propylene or butadiene), and a copolymer composed of two or more of these monomers in combination. The binder resin of the toner particle also includes, for example, a non-vinyl resin, for example, a polyester resin, an epoxy resin, a polyurethane resin, a polyimide resin, a cellulose resin, a polyether resin or a modified rosin, a mixture thereof with the vinyl resin, and a graft polymer obtained by polymerizing the vinyl monomer in the presence of the resin. The binder resins may be used individually or in combination of two or more thereof.

In the exemplary embodiment of the invention, an aspect wherein an amorphous resin and a crystalline resin are used together as the binder resin of the toner particle is desirable. As to the crystalline resin, since the change of viscosity around the melting temperature is large and the temperature difference between the initiation of thermal activity of the molecule and the melting thereof is relatively small, preservation stability and low temperature fixability of the toner particle are increased by incorporating the crystalline resin into the toner particle. The content of the crystalline resin in the toner particle is preferably from 1% by weight to 10% by weight, and more preferably from 2% by weight to 8% by weight.

A polyester resin is desirable as the binder resin of the toner particle. As the polyester resin, an amorphous polyester resin and a crystalline polyester resin may be used together. In the case of using the crystalline polyester resin, the ratio of the crystalline polyester resin occupied in the total binder resin is desirably from 2% by weight to 40% by weight, and preferably from 2% by weight to 20% by weight.

The term “crystalline” as used in the resin means that the resin does not exhibit stepwise endotherm change but have a clear endothermic peak in differential scanning calorimetry (DSC), and specifically, that the resin has the half width of the endothermic peak measured at a temperature rising rate of 10° C./min is within 10° C. The term “amorphous” as used in the resin means that the resin has the half width of the endothermic peak exceeding 10° C., exhibits the stepwise endotherm change or does not exhibit the clear endothermic peak.

### •Amorphous Polyester Resin

The amorphous polyester resin includes, for example, a condensation polymer of a polyvalent carboxylic acid and a polyhydric alcohol.

The polyvalent carboxylic acid includes, for example, an aliphatic dicarboxylic acid (for example, oxalic acid, malonic acid, maleic acid, fumaric acid, citraconic acid, itaconic acid, glutaconic acid, succinic acid, an alkenyl succinic acid, adipic acid or sebacic acid), an alicyclic dicarboxylic acid (for example, cyclohexanedicarboxylic acid), an aromatic dicarboxylic acid (for example, terephthalic acid, isophthalic acid, phthalic acid or naphthalenedicarboxylic acid), an anhydride thereof, and a lower alkyl (for example, having from 1 to 5 carbon atoms) ester thereof. Among them, the polyvalent carboxylic acid is preferably, for example, an aromatic dicarboxylic acid.

As the polyvalent carboxylic acid, a trivalent or higher valent carboxylic acid forming a crosslinked structure or a branched structure may be used together with the dicarboxylic acid. The trivalent or higher valent carboxylic acid includes, for example, trimellitic acid, pyromellitic acid, an anhydride thereof and a lower alkyl (for example, having from 1 to 5 carbon atoms) ester thereof.

The polyvalent carboxylic acids may be used individually or in combination of two or more thereof.

The polyhydric alcohol includes, for example, an aliphatic diol (for example, ethylene glycol, diethylene glycol, triethylene glycol, propylene glycol, butanediol, hexanediol or neopentyl glycol), an alicyclic diol (for example, cyclohexanediol, cyclohexane dimethanol or hydrogenated bisphenol A), and an aromatic diol (for example, ethylene oxide adduct of bisphenol A or propylene oxide adduct of bisphenol A). Among them, the polyhydric alcohol is preferably, for example, an aromatic diol or an alicyclic diol, and more preferably an aromatic diol.

As the polyhydric alcohol, a trivalent or higher valent polyhydric alcohol forming a crosslinked structure or a branched structure may be used together with the diol. The trivalent or higher valent polyhydric alcohol includes, for example, glycerol, trimethylolpropane and pentaerythritol.

The polyhydric alcohols may be used individually or in combination of two or more thereof.

The glass transition temperature (Tg) of the amorphous polyester resin is preferably from 50° C. to 80° C., more preferably from 50° C. to 65° C., and still more preferably from 55° C. to 65° C.

The weight average molecular weight (Mw) of the amorphous polyester resin is preferably from 5,000 to 1,000,000, more preferably from 7,000 to 500,000, still more preferably from 8,000 to 30,000, and yet more preferably from 8,000 to 20,000. The number average molecular weight (Mn) of the amorphous polyester resin is preferably from 2,000 to 100,000. The molecular weight distribution Mw/Mn of the amorphous polyester resin is preferably from 1.5 to 100, and more preferably from 2 to 60.

The amorphous polyester resin is obtained by a known production method. Specifically, the amorphous polyester resin is obtained, for example, by a method where the polymerization temperature is set to be from 180° C. to 230° C. and, if desired, by reducing the pressure in the reaction system, the reaction is performed while removing water or an alcohol generating at the time of condensation.

In the case where the monomer of raw material is insoluble or incompatible at the reaction temperature, the monomer may be dissolved by adding a high boiling point solvent as a dissolution aid. In this case, the polycondensation reaction is performed while distilling off the dissolution aid. In the case where a monomer having poor compatibility in the copolymerization reaction is present, the monomer having poor compatibility may be condensed in advance with an acid or an alcohol to be polycondensed with the monomer, and then polycondensed together with the main component.

### •Crystalline Polyester Resin

The crystalline polyester resin includes, for example, a polycondensate of a polyvalent carboxylic acid and a polyhydric alcohol. As the crystalline polyester resin, in order to easily form the crystalline structure, a polycondensate obtained by using a straight-chain aliphatic polymerizable monomer than a polymerizable monomer having an aromatic ring is preferred.

The polyvalent carboxylic acid includes, for example, an aliphatic dicarboxylic acid (for example, oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid or 1,18-octadecanedicarboxylic acid), an aromatic dicarboxylic acid (for example, a dibasic acid, for example, phthalic acid, isophthalic acid, terephthalic acid or naphthalene-2,6-dicarboxylic acid), an anhydride thereof, and a lower alkyl (for example, having from 1 to 5 carbon atoms) ester thereof.

As the polyvalent carboxylic acid, a trivalent or higher valent carboxylic acid forming a crosslinked structure or a branched structure may be used together with a dicarboxylic acid. The trivalent or higher valent carboxylic acid includes, for example, an aromatic carboxylic acid (for example, 1,2,3-benzenetricarboxylic acid, 1,2,4-benzenetricarboxylic acid or 1,2,4-naphthalenetricarboxylic acid), an anhydride thereof and a lower alkyl (for example, having from 1 to 5 carbon atoms) ester thereof.

As the polyvalent carboxylic acid, a dicarboxylic acid having a sulfonic acid group or a dicarboxylic acid having an ethylenic double bond may be used together with the dicarboxylic acid.

The polyvalent carboxylic acids may be used individually or in combination of two or more thereof.

The polyhydric alcohol includes, for example, an aliphatic diol (for example, a straight-chain aliphatic diol having from 7 to 20 carbon atoms in the main chain). The aliphatic diol includes, for example, ethylene glycol, 1,3-propanediol, 1,4-butanediol, 1,5-pentanediol, 1,6-hexanediol, 1,7-heptanediol, 1,8-octanediol, 1-9-nonanediol, 1,10-decanediol, 1,11-undecanediol, 1,12-dodecanediol, 1,13-tridecanediol, 1,14-tetradecanediol, 1,18-octadecanediol and 1,14-eicosanedecanediol. Among them, 1,8-octanediol, 1,9-nonanediol and 1,10-decanediol are preferred as the aliphatic diol.

As the polyhydric alcohol, a trivalent or higher valent alcohol forming a crosslinked structure or a branched structure may be used together with the diol. The trivalent or higher valent alcohol includes, for example, glycerol, trimethylolethane, trimethylolpropane and pentaerythritol.

The polyhydric alcohols may be used individually or in combination of two or more thereof. However, the ratio of the aliphatic diol occupied in the total polyhydric alcohol is preferably 80% by mole or more, and more preferably 90% by mole or more.

The melting temperature (Tm) of the crystalline polyester resin is preferably from 45° C. to 110° C., more preferably from 50° C. to 100° C., still more preferably from 55° C. to 90° C., and yet more preferably from 60° C. to 85° C.

The weight average molecular weight (Mw) of the crystalline polyester resin is preferably more than 5,000, more preferably 6,000 or more, still more preferably 10,000 or more, and preferably 35,000 or less. The number average molecular weight (Mn) of the crystalline polyester resin is preferably 2,000 or more, and more preferably 4,000 or more.

The crystalline polyester resin is obtained, for example, by a known production method same as in the amorphous polyester resin.

In the toner particle in the exemplary embodiment of the invention, the total content of the binder resin is, for example, preferably from 40% by weight to 95% by weight, more preferably from 50% by weight to 90% by weight, still more preferably from 60% by weight to 85% by weight, based on the total toner particles.

### [Coloring Agent]

The coloring agent includes, for example, pigment, for example, carbon black, Chrome Yellow, Hansa Yellow, Benzidine Yellow, Threne Yellow, Quinoline Yellow, Pigment Yellow, Permanent Orange GTR, Pyrazolone Orange, Vulcan Orange, Watchung Red, Permanent Red, Brilliant Carmine 3B, Brilliant Carmine 6B, DuPont Oil Red, Pyrazolone Red, Lithol Red, Rhodamine B Lake, Lake Red C, Pigment Red, Rose Bengal, Aniline Blue, Ultramarine Blue, Calco Oil Blue, Methylene Blue Chloride, Phthalocyanine Blue, Pigment Blue, Phthalocyanine Green or Malachite Green Oxalate; and dye, for example acridine type, xanthene type, azo type, benzoquinone type, azine type, anthraquinone type, thioindigo type, dioxazine type, thiazine type, azomethine type, indigo type, phthalocyanine type, aniline black type, polymethine type, triphenylmethane type, diphenylmethane type or thiazole type.

The coloring agents may be used individually or in combination of two or more thereof.

As to the coloring agent, if desired, a surface-treated coloring agent may be used, or the coloring agent may be used together with a dispersant. Moreover, plural kinds of coloring agents may be used in combination.

The content of the coloring agent is, for example, preferably from 1% by weight to 30% by weight, more preferably from 1% by weight to 20% by weight, still more preferably from 3% by weight to 15% by weight, based on the total toner particles.

### [Release Agent]

The release agent includes, for example, a low molecular weight polyolefin, for example, polyethylene, polypropylene or polybutene; a silicone; an aliphatic amide, for example, oleic amide, erucic amide, linoleic amide or stearic amide; a vegetable wax, for example, carnauba wax, rice wax, candelilla wax, Japan wax or jojoba oil; an animal wax, for example, beeswax; a mineral/petroleum wax, for example, montan wax, ozokerite, ceresin, paraffin wax, microcrystalline wax or Fischer-Tropsch wax. The release agents may be used individually or in combination of two or more thereof.

The melting temperature of the release agent is preferably from 50° C. to 110° C., and more preferably from 60° C. to 100° C. The melting temperature of the release agent is determined from a DSC curve obtained by differential scanning calorimetry (DSC) in accordance with “melting peak temperature” described in the method of obtaining melting temperature in JIS K7121: 1987 “Testing methods for transition temperatures of plastics”.

The content of the release agent is, for example, preferably from 0.5% by weight to 50% by weight, more preferably from 1% by weight to 30% by weight, still more preferably from 1% by weight to 20% by weight, yet more preferably from 5% by weight to 15% by weight, based on the total toner particles.

### [Other Additives]

Other additives include, for example, known additives, for example, a magnetic material, a charge controlling agent or an inorganic powder. The additive is contained in the toner particle as an internal additive.

### [External Additive]

The external additive for the toner particle includes, for example, an inorganic particle. The inorganic particle includes, for example, SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, A1₂O₃.2SiO₂, CaCO₃, MgCO₃, BaSO₄, MgSO₄ and Ca₃(PO₄)₂.

The surface of the inorganic particle as the external additive is preferably subjected to a hydrophobic treatment. The hydrophobic treatment is performed, for example, by immersing the inorganic particle in a hydrophobic treatment agent. The hydrophobic treatment agent is not particularly limited, and includes, for example, a silane coupling agent, a silicone oil, a titanate coupling agent or an aluminum coupling agent. The hydrophobic treatment agents may be used individually or in combination of two or more thereof. The amount of the hydrophobic treatment agent is, for example, from 1 part by weight to 10 parts by weight, based on 100 parts by weight of the inorganic particle.

The external additive also includes, for example, a resin particle (resin particle of polystyrene, polymethyl methacrylate, a melamine resin, a polyester resin, a silicone resin or the like) and a cleaning activator (for example, a metal salt of higher fatty acid represented by zinc stearate or a particle of fluorine-based compound having a high molecular weight).

The external addition amount of the external additive is, for example, preferably from 0.01% by weight to 5% by weight, more preferably from 0.01% by weight to 2.0% by weight, based on the toner particle.

### [Production Method of Liquid Developer]

The liquid developer according to the exemplary embodiment of the invention is produced, for example, through a granulation step for producing toner coarse particle and a wet pulverization step for pulverizing the toner coarse particle in a carrier liquid.

The granulation step may be performed by any of a dry production method (for example, a kneading pulverization method) and a wet production method (for example, an aggregation coalescence method, a suspension polymerization method or a dissolution suspension method). The production method is not particularly limited, and a known production method may be adopted. It is preferred that the toner coarse particle obtained by the wet production method are subjected to a cleaning step, a solid/liquid separation step and a drying step, thereby obtaining toner coarse particle in the dry state. The toner coarse particle in the dry state may be mixed with an external agent to allow the external agent to adhere to the surface of the toner coarse particle.

In the wet pulverization step, after dispersing the toner coarse particles in a carrier liquid, for example, the toner coarse particle is wet-pulverized in the carrier liquid using a media type wet pulverizer, for example, a beads mill, a ball mill, a sand mill or an atriter. The specific dispersant is, for example, added previously to the carrier liquid, and the toner coarse particle is dispersed in the carrier liquid containing the specific dispersant to perform the wet pulverization. Alternatively, after wet-pulverizing the toner coarse particle in the carrier liquid, the specific dispersant is added to the carrier liquid.

In addition, the liquid developer according to the exemplary embodiment of the invention is produced, for example, by producing toner particle in a solvent by a wet production method and, if desired, substituting the solvent with a carrier liquid. In the production method, the wet production method may be any of an aggregation coalescence method, a suspension polymerization method, a dissolution suspension method and the like, and a known production method may be adopted. The solvent used in the wet production method is preferably a same kind of solvent as the carrier liquid, a solvent which can be substituted with the carrier liquid (for example, a solvent having a boiling point lower than that of the carrier liquid) or a mixed solvent thereof. In the production method, for example, the carrier liquid containing the specific dispersant is used in the wet production method, or the solvent used in the wet production method is substituted with the carrier liquid containing the specific dispersant.

As to the content ratio of the carrier liquid and the toner particle in the liquid developer according to the exemplary embodiment of the invention, for example, the content of the toner particle is from 15 parts by weight to 40 parts by weight to 100 parts by weight of the carrier liquid.

### <<Liquid Developer Cartridge>>

The liquid developer cartridge according to the exemplary embodiment of the invention stores the liquid developer according to the exemplary embodiment of the invention and is detachably mounted in an image forming apparatus. The liquid developer stored in the liquid developer cartridge according to the exemplary embodiment of the invention is supplied to a developing unit of an image forming apparatus through a supply pipe or the like installed in the image forming apparatus. The form of the liquid developer cartridge according to the exemplary embodiment of the invention is not limited, and includes, for example, a tank-like form or a bottle-like form. The capacity of the liquid developer cartridge according to the exemplary embodiment of the invention may be selected depending on the size of the image forming apparatus.

### <<Image Forming Apparatus and Image Forming Method>>

The image forming apparatus according to the exemplary embodiment of the invention includes an image holding member, a charging unit which charges a surface of the image holding member, an electrostatic charge image forming unit which forms an electrostatic charge image on a charged surface of the image holding member, a developing unit which stores a liquid developer and develops the electrostatic charge image formed on the surface of the image holding member by using the liquid developer to form a toner image, a transfer unit which transfers the toner image formed on the surface of the image holding member to a surface of a recording medium, and a fixing unit which fixes the toner image transferred to the surface of the recording medium. The image forming apparatus according to the exemplary embodiment of the invention uses the liquid developer according to the exemplary embodiment of the invention as the liquid developer.

In the image forming apparatus according to the exemplary embodiment of the invention, an image forming method (image forming method according to the exemplary embodiment of the invention) which includes a charging step for charging a surface of an image holding member, an electrostatic charge image forming step for forming an electrostatic charge image on a charged surface of the image holding member, a developing step for developing the electrostatic charge image formed on the surface of the image holding member by using a liquid developer to form a toner image, a transfer step for transferring the toner image formed on the surface of the image holding member to a surface of a recording medium, and a fixing step for fixing the toner image transferred to the surface of the recording medium is performed.

The image forming apparatus according to the exemplary embodiment of the invention is an image forming apparatus, for example, a direct transfer type apparatus in which a toner image formed on the surface of an image holding member is directly transferred to a recording medium; an intermediate transfer type apparatus in which a toner image formed on the surface of an image holding member is primarily transferred to a surface of an intermediate transfer member, and the toner image transferred on the surface of the intermediate transfer member is secondary transferred on a surface of a recording medium; an apparatus which is provided with a cleaning unit for cleaning a surface of an image holding member after transfer of a toner image and before charging; and an apparatus which is provided with a charge erasing unit for easing charge by irradiating light for erasing a surface of an image holding member after transfer of a toner image and before charging. In the case where the image forming apparatus according to the exemplary embodiment of the invention is an intermediate transfer type apparatus, a transfer unit includes, for example, an intermediate transfer member having a surface on which a toner image is transferred, a primary transfer unit which primarily transfers a toner image formed on a surface of an image holding member to the surface of the intermediate transfer member, and a secondary transfer unit which secondarily transfers the toner image transferred on the surface of the intermediate transfer member on a surface of a recording medium.

In the image forming apparatus (image forming method) according to the exemplary embodiment of the invention, a fixing device (fixing step) desirably has a form of performing two-stage fixing. Specifically, the fixing device (fixing step) desirably has a non-contact type heating device (non-contact type heating step) which performs contactless heating of a toner image, and a heating and pressurizing device (heating and pressurizing step) which applies pressure with heating after heating by the non-contact type heating device (after the non-contact type heating step).

The recording medium is not particularly limited, and known recording media can be used. For example, a thermoplastic resin film, paper and an OHP sheet are exemplified. The application of the thermoplastic resin film includes, for example, a label, a packaging material and a poster.

The thermoplastic resin film includes, for example, a polyolefin film, for example, a polyethylene film or a polypropylene film; a polyester film, for example, a polyethylene terephthalate film or a polybutylene terephthalate film; a polyamide film, for example, a nylon film; films of polycarbonate, polystyrene, modified polystyrene, polyvinyl chloride, polyvinyl alcohol, polylactic acid and the like. The thermoplastic resin film may be any of an unstretched film and a stretched film which is stretched in a monoaxial direction or a biaxial direction. The thermoplastic resin film may be any of a monolayer form and a multilayer form. The thermoplastic resin film may be a film having a surface coat layer for assisting toner fixing, or a film subjected to a corona treatment, an ozone treatment, a plasma treatment, a flame treatment, a glow discharge treatment or the like. A thickness of the thermoplastic resin film for use in a soft packaging material is, for example, from 5 μm to 250 μm, and desirably from 10 μm to 100 μm.

Hereinafter, the image forming apparatus according to the exemplary embodiment of the invention will be described with reference to drawing.

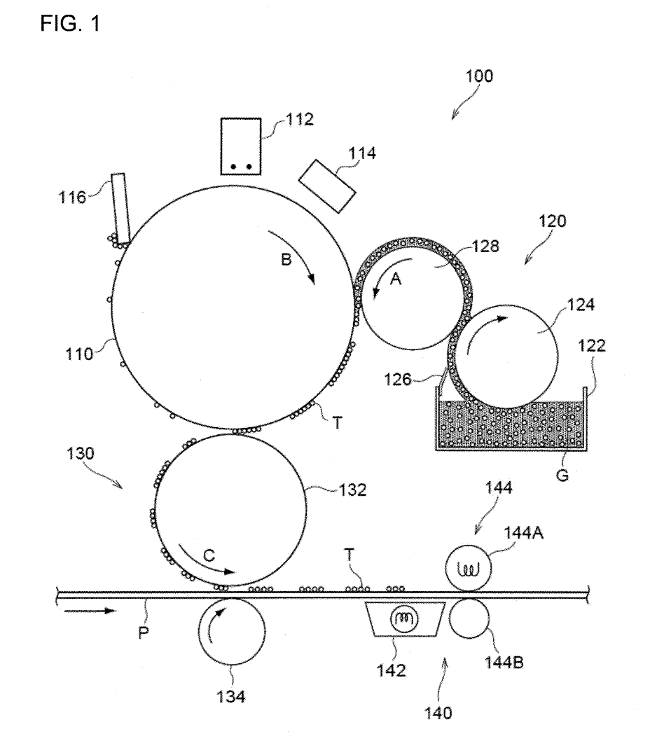

FIG. 1 is a schematic constitutional view showing an example of an image forming apparatus relating to an exemplary embodiment of the invention.

An image forming apparatus 100 shown in FIG. 1 includes a photoreceptor 110 (an example of image holding member), a charging device 112 (an example of charging unit), an exposure device 114 (an example of electrostatic charge image forming unit), a developing device 120 (an example of developing unit), a transfer device 130 (an example of transfer unit), a fixing device 140 (an example of fixing unit), and a cleaner 116.

The photoreceptor 110 has a cylindrical form, and at the circumference of the photoreceptor 110, the charging device 112, the exposure device 114, the developing device 120, the transfer device 130 and the cleaner 116 are sequentially provided.

The charging device 112 charges the surface of the photoreceptor 110.

The exposure device 114 exposes the charged surface of the photoreceptor 110, for example, with laser beams based on the image signal to form an electrostatic charge image.

The developing device 120 includes a developer storing container 122, a developer supply roll (anilox roll) 124, a regulating member 126, and a developing roll 128.

The developer storing container 122 stores a liquid developer G. The developer storing container 122 may be equipped with a stirring member (not shown in the drawing) for stirring the liquid developer G.

A part of the developer supply roll 124 is dipped in the liquid developer G stored in the developer storing container 122, disposed so as to come close to (or contact) the developing roll 128, and supplies the liquid developer G in the developer storing container 122 to the surface of the developing roll 128. The regulating member 126 controls the amount of the liquid developer G supplied by the developer supply roll 124.

The developing roll 128 maintains the liquid developer G supplied from the developer supply roll 124, and the electrostatic charge image formed on the surface of the photoreceptor 110 is developed with the liquid developer G developed to form a toner image T.

The transfer device 130 is a device of an intermediate transfer type which includes a drum-like intermediate transfer member 132 to which the toner image T having been formed on the surface of the photoreceptor 110 is transferred, and a transfer roll 134 which transfers the toner image T having been transferred onto the surface of the intermediate transfer member 132 to a recording medium P.

The transfer device 130 may be constituted, for example, with a belt-like intermediate transfer member 132. The transfer device 130 does not include the intermediate transfer member 132 and may have a constitution of a direct transfer type in which the toner image T is directly transferred to the recording medium P from the photoreceptor 110 by the transfer roll 134.

The fixing device 140 is disposed on the downstream side than the transfer device 130 in the progress direction of the recording medium P and includes a non-contact type heating device 142 and a heating and pressurizing device 144.

The non-contact type heating device 142 is, for example, a plate-shaped heating device including a heat source in the inside of a housing made of metal. The non-contact type heating device 142 may include an air blower together with the heat source in the inside of the housing. The non-contact type heating device 142 may be provided on the side of the recording medium on which the toner image is formed, may be provided on the rear side (side on which no toner image is formed) of the recording medium, or may be provided on the both sides of the recording medium.

The heating and pressurizing device 144 is, for example, a pair of a heating roll 144A and a pressurizing roll 144B. The heating roll 144A and the pressurizing roll 144B are opposed so as to form a nip across the recording member. A heat source is provided in the inside of the heating roll 144A. In addition, the heating and pressurizing device 144 may be a device in which a heating and pressurizing roll and a pressurizing belt are combined, or a device in which a pressurizing roll and a heating and pressurizing belt are combined.

The cleaner 116 is disposed for the purpose of removing and collecting the residual toner remaining on the surface of the photoreceptor 110 after the toner image is transferred.

The image forming apparatus 100 may further include a charge erasing device (not shown in the drawing) which erases the charge on the surface of the photoreceptor 110 after the transfer and before the next charging.

Hereinafter, the image forming method using the image forming apparatus 100 will be described.

The charging device 112, the exposure device 114, the developing device 120, the transfer device 130, the fixing device 140, and the cleaner 116 are operated in synchronization with the rotation speed of the photoreceptor 110.

First, the charging device 112 charges the surface of the photoreceptor 110, which rotates in the direction of arrow B, with a predetermined potential.

Next, the exposure device 114 exposes the charged surface of the photoreceptor 110 based on the image signal to form an electrostatic charge image.

In the developing device 120, the developer supply roll 124 supplies the liquid developer G to the surface of the developing roll 128, and the developing roll 128, which rotates in the direction of arrow A, conveys the liquid developer G to the photoreceptor 110.

The liquid developer G is supplied to the electrostatic charge image on the photoreceptor 110 in a position where the developing roll 128 comes close to (or contact) the photoreceptor 110 to develop the electrostatic charge image (make into a visual image), thereby forming the toner image T.

Then, the toner image T on the surface of the photoreceptor 110 is transferred onto the surface of the intermediate transfer member 132 which rotates in the direction of arrow C.

Subsequently, the toner image T having been transferred on the surface of the intermediate transfer member 132 is transferred to the recording medium P in a position which contacts the transfer roll 134. In this transfer process, the recording medium P is interposed between the transfer roll 134 and the intermediate transfer member 132, and the toner image T on the surface of the intermediate transfer member 132 is adhered to the recording medium P.

The recording medium P to which the toner image T has been transferred is conveyed to the fixing device 140 and passed through the non-contact type heating device 142 and the heating and pressurizing device 144 in turn, thereby forming a fixed image on the surface of the recording medium P.

The heating temperature of the non-contact type heating device 142 in the case of using a thermoplastic resin film as the recording medium P is desirably 70° C. or more and less than 110° C., more desirably from 80° C. to 100° C., and still more desirably from 80° C. to 90° C. The tome for heating is determined according to the process speed of the non-contact type heating device 142.

The toner image which has been subjected to heating by the non-contact type heating device 142 is further subjected to heating and pressurizing by the heating and pressurizing device 144 (heating roll 144A and pressurizing roll 144B) to be fixed on the recording medium P.

The heating temperature of the heating and pressurizing device 144 in the case of using a thermoplastic resin film as the recording medium P is desirably 70° C. or more and less than 110° C., more desirably from 80° C. to 100° C., and still more desirably from 80° C. to 90° C. The pressure applied in the heating and pressurizing device 144 is desirably from 1.5 kg/cm² to 5 kg/cm², and more desirably from 2 kg/cm² to 3.5 kg/cm².

The photoreceptor 110 from which the toner image T has been transferred to the intermediate transfer member 132 is cleaned by the cleaner 116 to remove and collect the residual toner remaining after the transfer, and then moved again for the following charging step.

The image forming apparatus 100 may be a full color image forming apparatus of a tandem system in which the photoreceptor 110, the charging device 112, the exposure device 114, the developing device 120, the transfer device 130 and the cleaner 116 are integrated to form a unit and the four units are mounted side by side.

The image forming apparatus 100 may have a system in which the toner particle or externally added toner is supplied from a toner cartridge (not shown in the drawing) to the developer storing container 122, or may have a system in which the liquid developer is supplied from a liquid developer cartridge (not shown in the drawing) to the developer storing container 122. The toner cartridge or the liquid developer cartridge may be constructed to be detachable from the image forming apparatus so that the cartridge can be replaced when the amount of the remaining liquid developer becomes zero.

### EXAMPLES

The exemplary embodiment of the invention is described in detail with reference to the examples below, but the exemplary embodiment of the invention should not be construed as being limited to the examples. In the descriptions below, unless otherwise indicated, all “parts” and “%” are on a weight bases.

### Example Relating to Liquid Developer According to First Exemplary Embodiment of Invention

### <Synthesis of Dispersant>

### [Dispersant (1)]

Into a reaction vessel equipped with a nitrogen gas inlet tube, a stirrer, a thermometer and a reflux condenser are charged 50 parts of isoparaffin (Isopar L produced by Exxon Mobil Corp.), 29 parts of polysiloxane macromonomer (Silaplane FM-0711 produced by Chisso Corp.), 4 parts of N,N-dimethylaminoethyl methacrylate and 17 parts of methyl methacrylate, and substitution with nitrogen gas is performed. Into the reaction vessel is charged 0.4 parts of an oil-soluble azo polymerization initiator (V-65 produced by Wako Pure Chemical Industries, Ltd.) and the mixture is refluxed by heating with stirring. Polymerization reaction is conducted for 6 hours to prepare a solution of Dispersant (1) having a solid content of 50%.

### [Dispersants (2) to (9) and Comparative Dispersant (1) to (2)]

Each dispersant is synthesized to prepare a solution of dispersant in the same manner as in Dispersant (1) except for changing the kind and amount of the monomer to those as shown in Table 1.

### [Dispersant (10)]

The polymerization reaction is conducted in the same manner as in Dispersant (1) except for changing the polymerization solvent to a mixed solvent of Isopar L and isopropanol (1:1 in weight ratio) and changing the kind and amount of the monomer to those as shown in Table 1, and after the polymerization, isopropyl alcohol is distilled off under a reduced pressure and the resulting product is diluted with Isopar L to prepare a solution of the dispersant having a solid content of 50%.

### [Dispersant (11)]

The polymerization reaction is conducted in the same manner as in Dispersant (1) except for changing a part of N,N-dimethylaminoethyl methacrylate to glycidyl methacrylate, and then, ethylenediamine is added in the same amount of substance as the glycidyl methacrylate used in the polymerization reaction, the mixture is stirred at room temperature for 90 minutes and then stirred at 60° C. for 6 hours to prepare a solution of the dispersant having a solid content of 50%.

The compositions of respective dispersants are collectively shown in Table 1.

TABLE 1

| | | | Compar- | Compar- | | | | | |
|---|---|---|---|---|---|---|---|---|---|
| | | | ative | ative | | | | | |
| | Kind of | Origin of | Disper- | Disper- | Disper- | Disper- | Disper- | Disper- | Disper- |
| | Monomer | Monomer | sant | sant | sant | sant | sant | sant | sant |
| | Unit | Unit | (1) | (2) | (1) | (2) | (3) | (4) | (5) |
| Ratio of | Monomer | Silaplane | 14 | — | 14 | — | 14 | 25 | 14 |
| Mono- | Unit Having | FM-0711 | | | | | | | |
| mer | Polysiloxane | Silaplane | — | — | — | 6 | — | — | — |
| Unit | Chain | FM-0721 | | | | | | | |
| [mol %] | (polysiloxane | | | | | | | | |
| | macromonomer) | | | | | | | | |
| | Monomer | Dimethylami- | — | 10 | 10 | 19 | — | 10 | 20 |
| | Unit Having | noethyl | | | | | | | |
| | Tertiary | Methacrylate | | | | | | | |
| | Amino Group | Diethylami- | — | — | — | — | 10 | — | — |
| | | noethyl | | | | | | | |
| | | Methacrylate | | | | | | | |
| | Monomer | 2-(Methylami- | — | — | — | — | — | — | — |
| | Unit Having | no)ethyl | | | | | | | |
| | Secondary | Methacrylate | | | | | | | |
| | Amino Group | | | | | | | | |
| | Monomer | Monomer Unit | — | — | — | — | — | — | — |
| | Unit Having | Obtained by | | | | | | | |
| | Primary | Copoly- | | | | | | | |
| | Amino Group | merization | | | | | | | |
| | | with Glycidyl | | | | | | | |
| | | Methacrylate | | | | | | | |
| | | and | | | | | | | |
| | | Reaction with | | | | | | | |
| | | Ethylenediamine | | | | | | | |
| | Monomer | Dodecyl | 86 | — | — | — | — | — | — |
| | Unit Having | Methacrylate | | | | | | | |
| | Long-chain | Octadecyl | — | 90 | — | — | — | — | — |
| | Hydrocarbon | Methacrylate | | | | | | | |
| | Group | | | | | | | | |
| | Other | Methyl | — | — | 76 | 75 | 76 | 65 | 66 |
| | Monomer | Methacrylate | | | | | | | |
| | Unit | | | | | | | | |

| | | | | | | | |
|---|---|---|---|---|---|---|---|
| Weight Average Molecular Weight | 38,000 | 27,000 | 25,000 | 26,000 | 23,000 | 29,000 | 27,000 |

| | Kind of | Origin of | Disper- | Disper- | Disper- | Disper- | Disper- | Disper- |
|---|---|---|---|---|---|---|---|---|
| | Monomer | Monomer | sant | sant | sant | sant | sant | sant |
| | Unit | Unit | (6) | (7) | (8) | (9) | (10) | (11) |
| Ratio of | Monomer | Silaplane | 14 | 14 | 14 | 14 | 14 | 14 |
| Mono- | Unit Having | FM-0711 | | | | | | |
| mer | Polysiloxane | Silaplane | — | — | — | — | — | — |
| Unit | Chain | FM-0721 | | | | | | |
| [mol %] | (polysiloxane | | | | | | | |
| | macromonomer) | | | | | | | |
| | Monomer | Dimethylami- | 7 | 10 | 10 | 10 | 5 | 5 |
| | Unit Having | noethyl | | | | | | |
| | Tertiary | Methacrylate | | | | | | |
| | Amino Group | Diethylami- | — | — | — | — | — | — |
| | | noethyl | | | | | | |
| | | Methacrylate | | | | | | |
| | Monomer | 2-(Methylami- | — | — | — | — | 5 | — |
| | Unit Having | no)ethyl | | | | | | |
| | Secondary | Methacrylate | | | | | | |
| | Amino Group | | | | | | | |
| | Monomer | Monomer Unit | — | — | — | — | — | 5 |
| | Unit Having | Obtained by | | | | | | |
| | Primary | Copoly- | | | | | | |
| | Amino Group | merization | | | | | | |
| | | with Glycidyl | | | | | | |
| | | Methacrylate | | | | | | |
| | | and | | | | | | |
| | | Reaction with | | | | | | |
| | | Ethylenediamine | | | | | | |
| | Monomer | Dodecyl | — | — | — | 10 | — | — |
| | Unit Having | Methacrylate | | | | | | |
| | Long-chain | Octadecyl | — | — | — | — | — | — |
| | Hydrocarbon | Methacrylate | | | | | | |
| | Group | | | | | | | |
| | Other | Methyl | 79 | 76 | 76 | 66 | 76 | 76 |
| | Monomer | Methacrylate | | | | | | |
| | Unit | | | | | | | |

| | | | | | | |
|---|---|---|---|---|---|---|
| Weight Average Molecular Weight | 32,000 | 45,000 | 18,000 | 22,000 | 32,000 | 28,000 |

### <Production of Liquid Developer>

### Example 1

To 100 parts of polyester resin (copolymer of terephthalic acid:fumaric acid:bisphenol A ethylene oxide adduct:bisphenol A propylene oxide adduct=30 parts by mole:70 parts by mole:5 parts by mole:95 parts by mole, weight average molecular weight: 18,000, glass transition temperature: 60° C.) are added 40 parts of C. I. Pigment Blue 15:3 (copper phthalocyanine) and 50 parts of paraffin wax (HNP-9 produced by Nippon Seiro Co., Ltd.), and the mixture is kneaded by an extruder, and pulverized by a surface pulverizing type pulverizer. Then, the resulting mixture is classified into fine particles and coarse particles by a wind classifier to obtain toner coarse particles having a volume average particle diameter of 8 μm.

In 100 parts of isoparaffin (Isopar L produced by Exxon Mobil Corp.) is mixed the solution of Dispersant (1) so as to be the amount of Dispersant (1) being 0.5 parts, and then 25 parts of the toner coarse particles are added thereto. The mixture is subjected to wet pulverization using a wet pulverizer (DYNO-MILL KDL-A Model, produced by Shinmaru Enterprises Corp.) and zirconia beads having a diameter of 1.0 mm under conditions of 2,500 rpm for 180 minutes to obtain a liquid developer.

### Examples 2 to 11

Liquid developers are obtained in the same manner as in Example 1 except for changing Dispersant (1) to other dispersants as shown in Table 2, respectively.

### Examples 12 to 13

Liquid developers are obtained in the same manner as in Example 1 except for changing the carrier liquid to other chemical substances as shown in Table 2, respectively. The normal paraffin is Moresco White P-40 (produced by Moresco Corp.), and the naphthene is Naphtesol 200 (produced by JX Nippon Oil & Energy Corp.).

### Comparative Example 1

A liquid developer is obtained in the same manner as in Example 1 except for not using Dispersant (1).

### Comparative Examples 2 to 3

Liquid developers are obtained in the same manner as in Example 1 except for changing Dispersant (1) to other dispersants as shown in Table 2, respectively.

### Comparative Example 4

A liquid developer is obtained in the same manner as in Example 1 except for changing the carrier liquid to dimethyl silicone oil (KF-96-20cs produced by Shin-Etsu Chemical Co., Ltd.).

### <Evaluation of Liquid Developer>

The liquid developer of each of the examples and comparative examples is evaluated as shown below.

### [Dispersibility (1) of Toner Particle: Particle Size Distribution]

Volume-based particle size distribution of toner particle in the liquid developer is obtained by using a particle diameter measuring device (FPAR-1000 produced by Otsuka Electronics Co., Ltd.) according to the Marquardt method, GSDv=(Particle size of 84% accumulation D84v/Particle size of 16% accumulation D16v)^{1/2} is determined, and classified as shown below.

### G4: GSDv<1.25

### G3: 1.25≦GSDv<1.5

### G2: 1.5≦GSDv≦2

### G1: 2<GSDv

### [Dispersibility (2) of Toner Particle: Preservation Stability]

The liquid developer is stored in a thermostatic bath of 40° C. for 14 days, and when aggregation is not observed, the liquid developer is further stored under the same condition for 16 days (30 days in total). The liquid developer after the storage is visually observed and classified as shown below.

G4: No aggregation after 30 days and redispersible
G3: No aggregation after 14 days and redispersible, partial aggregation after 30 days
G2: Partial aggregation after 14 days
G1: Aggregated after 14 days and unredispersible

### [Fine Line Reproducibility]

The liquid developer is set in an image forming apparatus having the structure shown in FIG. 1, and formation of fine line images (ITE High-Definition Inmega Cycle Chart produced by DNP Co., Ltd.) is performed on a biaxially stretched polypropylene film (FOR produced by Futamura Chemical Co., Ltd., 15 μm in thickness). The fine line portion of the image is visually confirmed and classified as shown below.

G3: No bleeding and sharp image
G2: Partial bleeding
G1: Overall bleeding

### [Image Fixability]

On the fixed image is pasted an adhesive tape (Mending Tape 810 produced by 3M Co., 18 mm in width) with applying a load of 500 g, and then the adhesive tape is stripped off. The presence or absence of peeling of image is classified as shown below.

G3: No peeling of image
G2: Partial peeling of image
G1: Peeling occurs in a large area

TABLE 2

| | | | Compar- | Compar- | Compar- | Compar- | | | | | |
|---|---|---|---|---|---|---|---|---|---|---|---|
| | | | ative | ative | ative | ative | | | | | |
| | | | Exam- | Exam- | Exam- | Exam- | Exam- | Exam- | Exam- | Exam- | Exam- |
| | | | ple 1 | ple 2 | ple 3 | ple 4 | ple 1 | ple 2 | ple 3 | ple 4 | ple 5 |
| Composition | Carrier | Isoparaffin | 100 | 100 | 100 | — | 100 | 100 | 100 | 100 | 100 |
| of | Liquid | Normal | — | — | — | — | — | — | — | — | — |
| Liquid | | Paraffin | | | | | | | | | |
| Developer | | Naphthene | — | — | — | — | — | — | — | — | — |
| [parts | | Dimethyl | — | — | — | 100 | — | — | — | — | — |
| by | | Silicone | | | | | | | | | |
| weight] | | Oil | | | | | | | | | |
| | Dispersant | Comparative | — | 0.5 | — | — | — | — | — | — | — |
| | | Dispersant | | | | | | | | | |
| | | (1) | | | | | | | | | |
| | | Comparative | — | — | 0.5 | — | — | — | — | — | — |
| | | Dispersant | | | | | | | | | |
| | | (2) | | | | | | | | | |
| | | Dispersant | — | — | — | 0.5 | 0.5 | — | — | — | — |
| | | (1) | | | | | | | | | |
| | | Dispersant | — | — | — | — | — | 0.5 | — | — | — |
| | | (2) | | | | | | | | | |
| | | Dispersant | — | — | — | — | — | — | 0.5 | — | — |
| | | (3) | | | | | | | | | |
| | | Dispersant | — | — | — | — | — | — | — | 0.5 | — |
| | | (4) | | | | | | | | | |
| | | Dispersant | — | — | — | — | — | — | — | — | 0.5 |
| | | (5) | | | | | | | | | |
| | | Dispersant | — | — | — | — | — | — | — | — | — |
| | | (6) | | | | | | | | | |
| | | Dispersant | — | — | — | — | — | — | — | — | — |
| | | (7) | | | | | | | | | |
| | | Dispersant | — | — | — | — | — | — | — | — | — |
| | | (8) | | | | | | | | | |
| | | Dispersant | — | — | — | — | — | — | — | — | — |
| | | (9) | | | | | | | | | |
| | | Dispersant | — | — | — | — | — | — | — | — | — |
| | | (10) | | | | | | | | | |
| | | Dispersant | — | — | — | — | — | — | — | — | — |
| | | (11) | | | | | | | | | |

| | | | | | | | | | |
|---|---|---|---|---|---|---|---|---|---|
| Toner Particle | 25 | 25 | 25 | 25 | 25 | 25 | 25 | 25 | 25 |

| | | | | | | | | | |
|---|---|---|---|---|---|---|---|---|---|
| Volume Average Particle | — | — | 7.2 | 3.4 | 3.5 | 7.9 | 3.9 | 6.5 | 5.8 |
| Diameter of Toner Particle | | | | | | | | | |
| (just after production) [μm] | | | | | | | | | |
| Dispersibility (1) of Toner Particle | G1 | G1 | G2 | G3 | G4 | G3 | G4 | G3 | G3 |
| Dispersibility (2) of Toner Particle | — | — | G1 | G1 | G4 | G3 | G3 | G3 | G3 |
| Fine Line Reproducibility | — | — | G2 | G2 | G3 | G2 | G3 | G2 | G2 |
| Image Fixability | — | — | G2 | G2 | G3 | G2 | G3 | G2 | G2 |

| | | | Exam- | Exam- | Exam- | Exam- | Exam- | Exam- | Exam- | Exam- |
|---|---|---|---|---|---|---|---|---|---|---|
| | | | ple 6 | ple 7 | ple 8 | ple 9 | ple 10 | ple 11 | ple 12 | ple 13 |
| Composition | Carrier | Isoparaffin | 100 | 100 | 100 | 100 | 100 | 100 | — | — |
| of | Liquid | Normal | — | — | — | — | — | — | 100 | — |
| Liquid | | Paraffin | | | | | | | | |
| Developer | | Naphthene | — | — | — | — | — | — | — | 100 |
| [parts | | Dimethyl | — | — | — | — | — | — | — | — |
| by | | Silicone | | | | | | | | |
| weight] | | Oil | | | | | | | | |
| | Dispersant | Comparative | — | — | — | — | — | — | — | — |
| | | Dispersant | | | | | | | | |
| | | (1) | | | | | | | | |
| | | Comparative | — | — | — | — | — | — | — | — |
| | | Dispersant | | | | | | | | |
| | | (2) | | | | | | | | |
| | | Dispersant | — | — | — | — | — | — | 0.5 | 0.5 |
| | | (1) | | | | | | | | |
| | | Dispersant | — | — | — | — | — | — | — | — |
| | | (2) | | | | | | | | |
| | | Dispersant | — | — | — | — | — | — | — | — |
| | | (3) | | | | | | | | |
| | | Dispersant | — | — | — | — | — | — | — | — |
| | | (4) | | | | | | | | |
| | | Dispersant | — | — | — | — | — | — | — | — |
| | | (5) | | | | | | | | |
| | | Dispersant | 0.5 | — | — | — | — | — | — | — |
| | | (6) | | | | | | | | |
| | | Dispersant | — | 0.5 | — | — | — | — | — | — |
| | | (7) | | | | | | | | |
| | | Dispersant | — | — | 0.5 | — | — | — | — | — |
| | | (8) | | | | | | | | |
| | | Dispersant | — | — | — | 0.5 | — | — | — | — |
| | | (9) | | | | | | | | |
| | | Dispersant | — | — | — | — | 0.5 | — | — | — |
| | | (10) | | | | | | | | |
| | | Dispersant | — | — | — | — | — | 0.5 | — | — |
| | | (11) | | | | | | | | |

| | | | | | | | | |
|---|---|---|---|---|---|---|---|---|
| Toner Particle | 25 | 25 | 25 | 25 | 25 | 25 | 25 | 25 |

| | | | | | | | | |
|---|---|---|---|---|---|---|---|---|
| Volume Average Particle | 6.3 | 7.1 | 8.2 | 4.0 | 7.3 | 8.6 | 3.5 | 3.1 |
| Diameter of Toner Particle | | | | | | | | |
| (just after production) [μm] | | | | | | | | |
| Dispersibility (1) of Toner Particle | G3 | G3 | G3 | G4 | G3 | G3 | G4 | G4 |
| Dispersibility (2) of Toner Particle | G3 | G3 | G3 | G4 | G3 | G3 | G4 | G4 |
| Fine Line Reproducibility | G2 | G2 | G2 | G3 | G2 | G2 | G3 | G3 |
| Image Fixability | G2 | G2 | G2 | G3 | G2 | G2 | G3 | G3 |

In the evaluation items of Table 2, “-” means that the effective measurement or image formation cannot be performed.

### Example Relating to Liquid Developer According to Second Exemplary Embodiment of Invention

### <Synthesis of Dispersant>

### [Dispersant (2-1)]

Polyester diol (Priplast 1901 produced by Croda Japan KK., polyester diol having hydroxyl groups at both terminals) is allowed to react with methacryloyl chloride to obtain a methacrylic acid ester compound in which one terminal of cyclic polyester is modified with methacrylic acid.

Into a reaction vessel equipped with a nitrogen gas inlet tube, a stirrer, a thermometer and a reflux condenser are charged 50 parts of isoparaffin (Isopar L produced by Exxon Mobil Corp.), 5 parts of the methacrylic acid ester compound described above, 4 parts of N,N-dimethylaminoethyl methacrylate and 41 parts of dodecyl methacrylate, and substitution with nitrogen gas is performed. Into the reaction vessel is charged 0.4 parts of an oil-soluble azo polymerization initiator (V-65 produced by Wako Pure Chemical Industries, Ltd.) and the mixture is refluxed by heating with stirring. Polymerization reaction is conducted for 6 hours to prepare a solution of Dispersant (2-1) having a solid content of 50%.

### [Dispersants (2-2) to (2-10) and Comparative Dispersant (2-1) to (2-2)]

Each dispersant is synthesized to prepare a solution of dispersant in the same manner as in Dispersant (2-1) except for changing the kind and amount of the monomer to those as shown in Table 3.

### [Dispersant (2-11)]

The polymerization reaction is conducted in the same manner as in Dispersant (2-1) except for changing the polymerization solvent to a mixed solvent of Isopar L and isopropanol (1:1 in weight ratio) and changing the kind and amount of the monomer to those as shown in Table 3, and after the polymerization, isopropyl alcohol is distilled off under a reduced pressure and the resulting product is diluted with Isopar L to prepare a solution of the dispersant having a solid content of 50%.

### [Dispersant (2-12)]

The polymerization reaction is conducted in the same manner as in Dispersant (2-1) except for changing a part of N,N-dimethylaminoethyl methacrylate to glycidyl methacrylate, and then, ethylenediamine is added in the same amount of substance as the glycidyl methacrylate used in the polymerization reaction, the mixture is stirred at room temperature for 90 minutes and then stirred at 60° C. for 6 hours to prepare a solution of the dispersant having a solid content of 50%.

The compositions of respective dispersants are collectively shown in Table 3.

TABLE 3

| | | | Compar- | Compar- | | | | | |
|---|---|---|---|---|---|---|---|---|---|
| | | | ative | ative | | | | | |
| | Kind of | Origin of | Disper- | Disper- | Disper- | Disper- | Disper- | Disper- | Disper- |
| | Monomer | Monomer | sant | sant | sant | sant | sant | sant | sant |
| | Unit | Unit | (2-1) | (2-2) | (2-1) | (2-2) | (2-3) | (2-4) | (2-5) |
| Ratio | Monomer | Methacrylic | 5 | — | 5 | — | — | 5 | 15 |
| of | Unit | Acid Ester | | | | | | | |
| Mono- | Having | Compound | | | | | | | |
| mer | Cyclic | Obtained by | | | | | | | |
| Unit | Polyester | Modifying | | | | | | | |
| [mol %] | Chain | One | | | | | | | |
| | | Terminal of | | | | | | | |
| | | Priplast 1901 | | | | | | | |
| | | with | | | | | | | |
| | | Methacrylic | | | | | | | |
| | | Acid | | | | | | | |
| | | Methacrylic | — | — | — | 5 | — | — | — |
| | | Acid Ester | | | | | | | |
| | | Compound | | | | | | | |
| | | Obtained by | | | | | | | |
| | | Modifying | | | | | | | |
| | | One | | | | | | | |
| | | Terminal of | | | | | | | |
| | | Priplast 3197 | | | | | | | |
| | | with | | | | | | | |
| | | Methacrylic | | | | | | | |
| | | Acid | | | | | | | |
| | | Methacrylic | — | — | — | — | 5 | — | — |
| | | Acid Ester | | | | | | | |
| | | Compound | | | | | | | |
| | | Obtained by | | | | | | | |
| | | Modifying | | | | | | | |
| | | One | | | | | | | |
| | | Terminal of | | | | | | | |
| | | Priplast 3186 | | | | | | | |
| | | with | | | | | | | |
| | | Methacrylic | | | | | | | |
| | | Acid | | | | | | | |
| | Monomer | Dimethylami- | — | 10 | 10 | 10 | 10 | — | 10 |
| | Unit | noethyl | | | | | | | |
| | Having | Methacrylate | | | | | | | |
| | Tertiary | Diethylami- | — | — | — | — | — | 10 | — |
| | Amino | noethyl | | | | | | | |
| | Group | Methacrylate | | | | | | | |
| | Monomer | 2-(Methylami- | — | — | — | — | — | — | — |
| | Unit | no)ethyl | | | | | | | |
| | Having | Methacrylate | | | | | | | |
| | Secondary | | | | | | | | |
| | Amino | | | | | | | | |
| | Group | | | | | | | | |
| | Monomer | Monomer Unit | — | — | — | — | — | — | — |
| | Unit | Obtained by | | | | | | | |
| | Having | Copoly- | | | | | | | |
| | Primary | merization | | | | | | | |
| | Amino | of Glycidyl | | | | | | | |
| | Group | Methacrylate | | | | | | | |
| | | and | | | | | | | |
| | | Reaction with | | | | | | | |
| | | Ethylene- | | | | | | | |
| | | diamine | | | | | | | |
| | Monomer | Dodecyl | 95 | 90 | 85 | 85 | 85 | 85 | 75 |
| | Unit | Methacrylate | | | | | | | |
| | Having | Octadecyl | — | — | — | — | — | — | — |
| | Long- | Methacrylate | | | | | | | |
| | chain | | | | | | | | |
| | Hydro- | | | | | | | | |
| | carbon | | | | | | | | |
| | Group | | | | | | | | |
| | Other | Methyl | — | — | — | — | — | — | — |
| | Monomer | Methacrylate | | | | | | | |
| | Unit | | | | | | | | |

| | | | | | | | |
|---|---|---|---|---|---|---|---|
| Weight Average Molecular Weight | 42,000 | 35,000 | 48,000 | 52,000 | 38,000 | 53,000 | 46,000 |

| | Kind of | Origin of | Disper- | Disper- | Disper- | Disper- | Disper- | Disper- | Disper- |
|---|---|---|---|---|---|---|---|---|---|
| | Monomer | Monomer | sant | sant | sant | sant | sant | sant | sant |
| | Unit | Unit | (2-6) | (2-7) | (2-8) | (2-9) | (2-10) | (2-11) | (2-12) |
| Ratio | Monomer | Methacrylic | 5 | 5 | 5 | 5 | 5 | 5 | 5 |
| of | Unit | Acid Ester | | | | | | | |
| Mono- | Having | Compound | | | | | | | |
| mer | Cyclic | Obtained by | | | | | | | |
| Unit | Polyester | Modifying | | | | | | | |
| [mol %] | Chain | One | | | | | | | |
| | | Terminal of | | | | | | | |
| | | Priplast 1901 | | | | | | | |
| | | with | | | | | | | |
| | | Methacrylic | | | | | | | |
| | | Acid | | | | | | | |
| | | Methacrylic | — | — | — | — | — | — | — |
| | | Acid Ester | | | | | | | |
| | | Compound | | | | | | | |
| | | Obtained by | | | | | | | |
| | | Modifying | | | | | | | |
| | | One | | | | | | | |
| | | Terminal of | | | | | | | |
| | | Priplast 3197 | | | | | | | |
| | | with | | | | | | | |
| | | Methacrylic | | | | | | | |
| | | Acid | | | | | | | |
| | | Methacrylic | — | — | — | — | — | — | — |
| | | Acid Ester | | | | | | | |
| | | Compound | | | | | | | |
| | | Obtained by | | | | | | | |
| | | Modifying | | | | | | | |
| | | One | | | | | | | |
| | | Terminal of | | | | | | | |
| | | Priplast 3186 | | | | | | | |
| | | with | | | | | | | |
| | | Methacrylic | | | | | | | |
| | | Acid | | | | | | | |
| | Monomer | Dimethylami- | 20 | 7 | 10 | 10 | 10 | 5 | 5 |
| | Unit | noethyl | | | | | | | |
| | Having | Methacrylate | | | | | | | |
| | Tertiary | Diethylami- | — | — | — | — | — | — | — |
| | Amino | noethyl | | | | | | | |
| | Group | Methacrylate | | | | | | | |
| | Monomer | 2-(Methylami- | — | — | — | — | — | 5 | — |
| | Unit | no)ethyl | | | | | | | |
| | Having | Methacrylate | | | | | | | |
| | Secondary | | | | | | | | |
| | Amino | | | | | | | | |
| | Group | | | | | | | | |
| | Monomer | Monomer Unit | — | — | — | — | — | — | 5 |
| | Unit | Obtained by | | | | | | | |
| | Having | Copoly- | | | | | | | |
| | Primary | merization | | | | | | | |
| | Amino | of Glycidyl | | | | | | | |
| | Group | Methacrylate | | | | | | | |
| | | and | | | | | | | |
| | | Reaction with | | | | | | | |
| | | Ethylene- | | | | | | | |
| | | diamine | | | | | | | |
| | Monomer | Dodecyl | 75 | 88 | 85 | — | 65 | 85 | 85 |
| | Unit | Methacrylate | | | | | | | |
| | Having | Octadecyl | — | — | — | 85 | — | — | — |
| | Long- | Methacrylate | | | | | | | |
| | chain | | | | | | | | |
| | Hydro- | | | | | | | | |
| | carbon | | | | | | | | |
| | Group | | | | | | | | |
| | Other | Methyl | — | — | — | — | 20 | — | — |
| | Monomer | Methacrylate | | | | | | | |
| | Unit | | | | | | | | |

| | | | | | | | |
|---|---|---|---|---|---|---|---|
| Weight Average Molecular Weight | 44,000 | 51,000 | 17,000 | 48,000 | 36,000 | 32,000 | 42,000 |

### <Production of Liquid Developer>

### Example 2-1

To 100 parts of polyester resin (copolymer of terephthalic acid:fumaric acid:bisphenol A ethylene oxide adduct:bisphenol A propylene oxide adduct=30 parts by mole:70 parts by mole:5 parts by mole:95 parts by mole, weight average molecular weight: 18,000, glass transition temperature: 60° C.) are added 40 parts of C. I. Pigment Blue 15:3 (copper phthalocyanine) and 50 parts of paraffin wax (HNP-9 produced by Nippon Seiro Co., Ltd.), and the mixture is kneaded by an extruder, and pulverized by a surface pulverizing type pulverizer. Then, the resulting mixture is classified into fine particles and coarse particles by a wind classifier to obtain toner coarse particles having a volume average particle diameter of 8 μm.

In 100 parts of isoparaffin (Isopar L produced by Exxon Mobil Corp.) is mixed the solution of Dispersant (2-1) so as to be the amount of Dispersant (2-1) being 0.5 parts, and then 25 parts of the toner coarse particles are added thereto. The mixture is subjected to wet pulverization using a wet pulverizer (DYNO-MILL KDL-A Model, produced by Shinmaru Enterprises Corp.) and zirconia beads having a diameter of 1.0 mm under conditions of 2,500 rpm for 180 minutes to obtain a liquid developer.

### Examples 2-2 to 2-12

Liquid developers are obtained in the same manner as in Example 2-1 except for changing Dispersant (2-1) to other dispersants as shown in Table 4, respectively.

### Examples 2-13 to 2-14

Liquid developers are obtained in the same manner as in Example 2-1 except for changing the carrier liquid to other chemical substances as shown in Table 4, respectively. The normal paraffin is Moresco White P-40 (produced by Moresco Corp.), and the naphthene is Naphtesol 200 (produced by JX Nippon Oil & Energy Corp.).

### Comparative Example 2-1

A liquid developer is obtained in the same manner as in Example 2-1 except for not using Dispersant (2-1).

### Comparative Examples 2-2 to 2-3

Liquid developers are obtained in the same manner as in Example 2-1 except for changing Dispersant (2-1) to other dispersants as shown in Table 4, respectively.

### <Evaluation of Liquid Developer>

The liquid developer of each of the examples and comparative examples is evaluated as shown below.

### [Dispersibility (1) of Toner Particle: Particle Size Distribution]

Volume-based particle size distribution of toner particle in the liquid developer is obtained by using a particle diameter measuring device (FPAR-1000 produced by Otsuka Electronics Co., Ltd.) according to the Marquardt method, GSDv=(Particle size of 84% accumulation D84v/Particle size of 16% accumulation D16v)^{1/2} is determined, and classified as shown below.

### G4: GSDv<1.25

### G3: 1.25≦GSDv<1.5

### G2: 1.5≦GSDv≦2

### G1: 2<GSDv

### [Dispersibility (2) of Toner Particle: Preservation Stability]

The liquid developer is stored in a thermostatic bath of 40° C. for 14 days, and when aggregation is not observed, the liquid developer is further stored under the same condition for 16 days (30 days in total). The liquid developer after the storage is visually observed and classified as shown below.

G4: No aggregation after 30 days and redispersible
G3: No aggregation after 14 days and redispersible, partial aggregation after 30 days
G2: Partial aggregation after 14 days
G1: Aggregated after 14 days and unredispersible

### [Fine Line Reproducibility]

The liquid developer is set in an image forming apparatus having the structure shown in FIG. 1, and formation of JEITA Test Chart IV (produced by DNP Co., Ltd.) is performed on a biaxially stretched polypropylene film (FOR produced by Futamura Chemical Co., Ltd., 15 μm in thickness). The image is visually confirmed and classified as shown below.

G3: No bleeding and sharp image
G2: Partial bleeding
G1: Overall bleeding

### [Image Fixability]

On the fixed image is pasted an adhesive tape (Mending Tape 810 produced by 3M Co., 18 mm in width) with applying a load of 500 g, and then the adhesive tape is stripped off. The presence or absence of peeling of image is classified as shown below.

G3: No peeling of image
G2: Partial peeling of image
G1: Peeling occurs in a large area

TABLE 4

| | | | Compar- | Compar- | Compar- | | | | | | |
|---|---|---|---|---|---|---|---|---|---|---|---|
| | | | ative | ative | ative | Exam- | | | | | |
| | | | Exam- | Exam- | Exam- | ple | Exam- | Exam- | Exam- | Exam- | Exam- |
| | | | ple 2-1 | ple 2-2 | ple 2-3 | 2-1 | ple 2-2 | ple 2-3 | ple 2-4 | ple 2-5 | ple 2-6 |
| Composition | Carrier | Isoparaffin | 100 | 100 | 100 | 100 | 100 | 100 | 100 | 100 | 100 |
| of | Liquid | Normal | — | — | — | — | — | — | — | — | — |
| Liquid | | Paraffin | | | | | | | | | |
| Developer | | Naphthene | — | — | — | — | — | — | — | — | — |
| [parts | Dispersant | Comparative | — | 0.5 | — | — | — | — | — | — | — |
| by | | Dispersant | | | | | | | | | |
| weight] | | (2-1) | | | | | | | | | |
| | | Comparative | — | — | 0.5 | — | — | — | — | — | — |
| | | Dispersant | | | | | | | | | |
| | | (2-2) | | | | | | | | | |
| | | Dispersant | — | — | — | 0.5 | — | — | — | — | — |
| | | (2-1) | | | | | | | | | |
| | | Dispersant | — | — | — | — | 0.5 | — | — | — | — |
| | | (2-2) | | | | | | | | | |
| | | Dispersant | — | — | — | — | — | 0.5 | — | — | — |
| | | (2-3) | | | | | | | | | |
| | | Dispersant | — | — | — | — | — | — | 0.5 | — | — |
| | | (2-4) | | | | | | | | | |
| | | Dispersant | — | — | — | — | — | — | — | 0.5 | — |
| | | (2-5) | | | | | | | | | |
| | | Dispersant | — | — | — | — | — | — | — | — | 0.5 |
| | | (2-6) | | | | | | | | | |
| | | Dispersant(2-7) | — | — | — | — | — | — | — | — | — |
| | | Dispersant | — | — | — | — | — | — | — | — | — |
| | | (2-8) | | | | | | | | | |
| | | Dispersant | — | — | — | — | — | — | — | — | — |
| | | (2-9) | | | | | | | | | |
| | | Dispersant | — | — | — | — | — | — | — | — | — |
| | | (2-10) | | | | | | | | | |
| | | Dispersant | — | — | — | — | — | — | — | — | — |
| | | (2-11) | | | | | | | | | |
| | | Dispersant | — | — | — | — | — | — | — | — | — |
| | | (2-12) | | | | | | | | | |

| | | | | | | | | | |
|---|---|---|---|---|---|---|---|---|---|
| Toner Particle | 25 | 25 | 25 | 25 | 25 | 25 | 25 | 25 | 25 |

| | | | | | | | | | |
|---|---|---|---|---|---|---|---|---|---|
| Volume Average Particle | — | — | 3.5 | 3.1 | 3.2 | 6.9 | 2.9 | 5.9 | 6.2 |
| Diameter of Toner Particle | | | | | | | | | |
| (just after production) [μm] | | | | | | | | | |
| Dispersibility (1) of Toner Particle | G1 | G1 | G3 | G4 | G4 | G4 | G4 | G4 | G4 |
| Dispersibility (2) of Toner Particle | — | — | G1 | G4 | G4 | G4 | G3 | G4 | G4 |
| Fine Line Reproducibility | — | — | G2 | G3 | G3 | G2 | G3 | G2 | G2 |
| Image Fixability | — | — | G2 | G3 | G3 | G2 | G3 | G2 | G2 |

| | | | Exam- | Exam- | Exam- | Exam- | Exam- | Exam- | Exam- | Exam- |
|---|---|---|---|---|---|---|---|---|---|---|
| | | | ple 2-7 | ple 2-8 | ple 2-9 | ple 2-10 | ple 2-11 | ple 2-12 | ple 2-13 | ple 2-14 |
| Composition | Carrier | Isoparaffin | 100 | 100 | 100 | 100 | 100 | 100 | — | — |
| of | Liquid | Normal | — | — | — | — | — | — | 100 | — |
| Liquid | | Paraffin | | | | | | | | |
| Developer | | Naphthene | — | — | — | — | — | — | — | 100 |
| [parts | Dispersant | Comparative | — | — | — | — | — | — | — | — |
| by | | Dispersant | | | | | | | | |
| weight] | | (2-1) | | | | | | | | |
| | | Comparative | — | — | — | — | — | — | — | — |
| | | Dispersant | | | | | | | | |
| | | (2-2) | | | | | | | | |
| | | Dispersant | — | — | — | — | — | — | 0.5 | 0.5 |
| | | (2-1) | | | | | | | | |
| | | Dispersant | — | — | — | — | — | — | — | — |
| | | (2-2) | | | | | | | | |
| | | Dispersant | — | — | — | — | — | — | — | — |
| | | (2-3) | | | | | | | | |
| | | Dispersant | — | — | — | — | — | — | — | — |
| | | (2-4) | | | | | | | | |
| | | Dispersant | — | — | — | — | — | — | — | — |
| | | (2-5) | | | | | | | | |
| | | Dispersant | — | — | — | — | — | — | — | — |
| | | (2-6) | | | | | | | | |
| | | Dispersant | 0.5 | — | — | — | — | — | — | — |
| | | (2-7) | | | | | | | | |
| | | Dispersant | — | 0.5 | — | — | — | — | — | — |
| | | (2-8) | | | | | | | | |
| | | Dispersant | — | — | 0.5 | — | — | — | — | — |
| | | (2-9) | | | | | | | | |
| | | Dispersant | — | — | — | 0.5 | — | — | — | — |
| | | (2-10) | | | | | | | | |
| | | Dispersant | — | — | — | — | 0.5 | — | — | — |
| | | (2-11) | | | | | | | | |
| | | Dispersant | — | — | — | — | — | 0.5 | — | — |
| | | (2-12) | | | | | | | | |

| | | | | | | | | |
|---|---|---|---|---|---|---|---|---|
| Toner Particle | 25 | 25 | 25 | 25 | 25 | 25 | 25 | 25 |

| | | | | | | | | |
|---|---|---|---|---|---|---|---|---|
| Volume Average Particle | 7.2 | 8.1 | 2.7 | 3.1 | 6.0 | 7.1 | 3.1 | 3.5 |
| Diameter of Toner Particle | | | | | | | | |
| (just after production) [μm] | | | | | | | | |
| Dispersibility (1) of Toner Particle | G4 | G4 | G4 | G4 | G3 | G3 | G4 | G4 |
| Dispersibility (2) of Toner Particle | G4 | G4 | G3 | G3 | G2 | G2 | G3 | G3 |
| Fine Line Reproducibility | G2 | G2 | G3 | G3 | G2 | G2 | G3 | G3 |
| Image Fixability | G2 | G2 | G3 | G3 | G2 | G2 | G3 | G3 |

In the evaluation items of Table 4, “-” means that the effective measurement or image formation cannot be performed.

What is claimed is:

1. A liquid developer comprising:
a toner particle;
a carrier liquid; and
either a polymer compound containing a monomer unit having a polysiloxane chain and a monomer unit having an amino group or a polymer compound containing a monomer unit having a polyester chain containing a cyclic structure and a monomer unit having an amino group.

2. The liquid developer as claimed in claim 1, wherein the carrier liquid comprises an aliphatic hydrocarbon as a main component.

3. The liquid developer as claimed in claim 1, wherein the carrier liquid is a non-volatile carrier liquid.

4. The liquid developer as claimed in claim 1, wherein an electric conductivity of the carrier liquid is 10⁻¹⁰ S/m or less.

5. The liquid developer as claimed in claim 1, wherein the monomer unit having an amino group is a monomer unit having a tertiary amino group.

6. The liquid developer as claimed in claim 1, wherein the polymer compound contains a monomer unit having a long-chain hydrocarbon group.

7. The liquid developer as claimed in claim 6, wherein a number of carbon atoms contained in the long-chain hydrocarbon group is from 10 to 20.

8. The liquid developer as claimed in claim 1, wherein a weight average molecular weight of the polymer compound is from 5,000 to 100,000.

9. The liquid developer as claimed in claim 1, wherein a volume average particle diameter of the toner particle is from 0.1 μm to 6 μm.

10. The liquid developer as claimed in claim 1, wherein the toner particle contains an amorphous polyester resin having a weight average molecular weight from 5,000 to 1,000,000.

11. The liquid developer as claimed in claim 10, wherein a glass transition temperature of the amorphous polyester resin is from 50° C. to 80° C.

12. The liquid developer as claimed in claim 1, wherein the toner particle contains a crystalline polyester resin having a weight average molecular weight exceeding 5,000.

13. The liquid developer as claimed in claim 1, wherein a content ratio of the monomer unit having a polysiloxane chain to total polymer units in the polymer compound is from 5% by mole to 25% by mole.

14. The liquid developer as claimed in claim 1, wherein a content ratio of the monomer unit having an amino group to total polymer units in the polymer compound is from 5% by mole to 25% by mole.

15. The liquid developer as claimed in claim 1, wherein a content ratio of the monomer unit having a polyester chain containing a cyclic structure to total polymer units in the polymer compound is from 1% by mole to 25% by mole.

16. The liquid developer as claimed in claim 1, wherein a weight average molecular weight of the polymer compound is from 5,000 to 50,000.

17. The liquid developer as claimed in claim 1, wherein the toner particle contains a release agent having a melting temperature from 50° C. to 110° C.

18. The liquid developer as claimed in claim 17, wherein a content of the release agent to total toner particles is from 0.5% by weight to 50% by weight.

19. A liquid developer cartridge that stores the liquid developer as claimed in claim 1 and is detachably mounted in an image forming apparatus.
